(19) United States
(12) Patent Application Publication
(10) Pub. No.: US 2026/0273645 A1
(43) Pub. Date: Sep. 17, 2026

(54) FLUID CONTROL TECHNIQUES FOR ARC PROCESS OPERATIONS

(71) Applicant: The ESAB Group, Inc., North Bethesda, MD (US)

(72) Inventor: Erik Anthony Leger, Newmarket, NH (US)

(21) Appl. No.: 19/675,774

(22) Filed: May 13, 2026

Related U.S. Application Data
(63) Continuation of application No. PCT/US2024/055843, filed on Nov. 14, 2024.
(60) Provisional application No. 63/599,290, filed on Nov. 15, 2023.

(51) Int. Cl. B23K 9/32; B23K 9/16

(52) U.S. Cl. CPC B23K 9/325; B23K 9/164

(57) ABSTRACT

A fluid control system for an arc processing system includes a first line configured to direct a first fluid from a first inlet of the fluid control system toward a torch, a second line configured to direct a second fluid from a second inlet of the fluid control system toward the torch, and a share line fluidly coupled to the first line and the second line. The second line includes a one-way valve configured to enable fluid flow away from the second inlet and block fluid flow toward the second inlet. The share line is configured to direct the first fluid from the first line to the second line and against the one-way valve to urge the one-way valve to close and block flow of the second fluid through the one-way valve and away from the second inlet within the fluid control system.

### CROSS-REFERENCE TO PREVIOUS APPLICATION

This application claims priority to and the benefit of International Patent Application No. PCT/US2024/055843, entitled “FLUID CONTROL TECHNIQUES FOR ARC PROCESS OPERATIONS,” filed Nov. 14, 2024, which claims priority to and the benefit of U.S. Provisional Patent Application No. 63/599,290, entitled “FLUID CONTROL TECHNIQUES FOR ARC PROCESS OPERATIONS,” filed Nov. 15, 2023, each of which is hereby incorporated by reference in its entirety for all purposes.

### FIELD OF INVENTION

The present disclosure is directed toward techniques that control a supply of fluid, such as process gas, for arc process operations (e.g., cutting or welding operations).

### BACKGROUND

During an arc processing operation (e.g., cutting or welding operation), it is important to control the fluid pressure through various stages of the arc processing operation. For example, in a plasma cutting operation, it may be important to control fluid pressure and flow based on the phase/stage of operation and/or current of the arc to stabilize the arc and prevent, or at least discourage, a hafnium insert at an operating end of an electrode from degrading (e.g., via melting). Precise control authority over pressure and flow to the torch is important particularly during the starting and extinguishing of the arc, where current ramping profiles are used to smoothly transition between phases.

Conventional systems often use the power supply to control gas pressure(s) in the system (e.g., plasma gas, shield gas, and/or other process gases), and changes in gas pressure must be carefully planned well in advance of a change in current of the plasma arc due to the distance between the point of control and the point of use, along which the fluid will incur frictional losses and response latency. For example, gas pressures can be planned based on a length of hose or cable between the torch and gas supply at the power source. In these instances, longer hoses between the gas source and the torch will increase the amount of time required to change the gas pressure at an output. Consequently, when using long hoses, changes in current must also be planned well in advance to prevent a mismatch of current and gas pressure. Then, to achieve the change, gas lines may be precharged for a period of time prior to a change, but the effect of this precharging is heavily dependent on environmental and systematic variables, usually requiring some kind of point-of-use gas control to mitigate response delays. Any non-controllable variable (e.g. a hose kink or slight variance in supply pressure) can change the pressure of a gas at the output (e.g., the plasma gas pressure) prior to the next stage of a cutting operation, which can cause damage to the torch tip and/or degrade cut quality.

Despite the foregoing disadvantages of pre-planning and precharging gas lines (e.g., cable hose) that extend between a power supply and a torch, these techniques continued to be in widespread use at least because electromagnetic interference (EMI) generated by the arc between the torch and workpiece often prevents reliable control of an electropneumatic pressure regulator at the torch via electrical signals. That is, the EMI may disrupt electrical signals sent between the torch pressure regulator and power supply. Therefore, the power supply cannot reliably control the gas pressure at the torch with an electrically controlled pressure regulator or valve without extensive EMI shielding or use of fiber optic communication. Both of these solutions add significant complexity and cost to the system. To mitigate this, some systems try to provide discrete gas control near a torch, relying on the natural ramping profile of the charged gas to the torch and modulating the current profile to match the gas ramp. These solutions are less expensive and less complex but are inherently unreliable and sensitive to external conditions due to the lack of active control.

### SUMMARY OF THE INVENTION

The fluid control techniques presented herein provide simplified and elegant fluid control near a torch for an arc process torch. Specifically, the techniques provide control authority at a remote fluid control system that can control flow of two respective fluids. For example, the remote fluid control system may include a first fluid line configured to direct a first fluid, a second fluid line configured to direct a second fluid, and a share fluid line that enables fluid flow between the two fluid lines. The fluid control system may be utilized to provide a wide variety of functions. For example, the fluid control techniques may allow the two fluid lines to share one of the two fluids, allow specific fluid(s) to be selected for each fluid line, transition the fluid lines between different fluid flows with low impulse transitions, provide precise fluid mixing, passively precharge fluid(s), and/or dynamically control a pressure of one or both fluid lines. Previously, systems providing similar functionality required a large number of valves and sensors—e.g., twenty-two valves and six pressure sensors. The techniques presented herein may reduce the number of components to two or three valves (or, at most, six valves). This provides dramatic cost savings, both during manufacturing and during operation (by reducing costs for maintenance, inventory stocking, monitoring, etc.).

In one embodiment, a fluid control system for an arc processing system includes a first fluid line configured to direct a first fluid from a first inlet of the fluid control system toward a torch of the arc processing system, a second fluid line configured to direct a second fluid from a second inlet of the fluid control system toward the torch, and a share fluid line fluidly coupled to the first fluid line and the second fluid line. The second fluid line includes a one-way valve configured to enable fluid flow therethrough away from the second inlet and block fluid flow therethrough toward the second inlet. The share fluid line is configured to direct the first fluid from the first fluid line to the second fluid line and against the one-way valve to urge the one-way valve to close and block flow of the second fluid through the one-way valve and away from the second inlet within the fluid control system.

In another embodiment, a torch system includes a fluid control system with a first fluid line extending from a first inlet of the fluid control system, a second fluid line extending from a second inlet of the fluid control system, and a share fluid line fluidly coupling the first fluid line and the second fluid line to one another. The second fluid line includes a one-way valve configured to enable fluid flow therethrough away from the second inlet and block fluid flow therethrough toward the second inlet. The torch system also includes a first supply line configured to direct a first fluid to the first inlet of the fluid control system and a second supply line configured to direct a second fluid to the second inlet of the fluid control system. The share fluid line is configured to direct the first fluid from the first fluid line to the one-way valve of the second fluid line.

In yet another embodiment, a torch system includes a fluid control system with a first fluid line configured to direct a first fluid within the fluid control system, a second fluid line configured to direct a second fluid within the fluid control system, and a share fluid line fluidly coupling the first fluid line and the second fluid line to one another. The second fluid line includes a one-way valve configured to enable fluid flow through the second fluid line in a first direction and block fluid flow through the second fluid line in a second direction, and the share fluid line includes a share valve configured to control fluid flow through the share fluid line. The torch system also includes a controller communicatively coupled to the share valve and configured to open the share valve to direct the first fluid from the first fluid line to the second fluid line and to the one-way valve and close the share valve to block fluid flow between the first fluid line and the second fluid line.

### BRIEF DESCRIPTION OF THE DRAWINGS

To complete the description and in order to provide for a better understanding of the techniques presented in this application, a set of drawings is provided. The drawings form an integral part of the description and illustrate an embodiment of the present application, which should not be interpreted as restricting the scope of the present application, but just as an example of how the techniques presented herein can be carried out. The drawings comprise the following figures:

FIG. 1A is a perspective view of an automated cutting system having a pneumatic control system that may execute the techniques presented herein, according to an example embodiment of the present disclosure.

FIG. 1B is perspective view of an automated cutting head that may be included in the automated cutting system illustrated in FIG. 1A, according to an example embodiment of the present disclosure.

FIG. 1C is a schematic, cross-sectional view of an end portion of a plasma torch, according to an example embodiment of the present disclosure.

FIG. 2 is a schematic-level block diagram of a torch system, which includes a fluid control system that may execute the techniques presented herein, according to an example embodiment of the present disclosure.

FIG. 3 is a detail view of a portion of the fluid control system depicted in FIG. 2.

FIGS. 4A and 4B illustrate the configuration of various components of a torch system through different phases of a cutting operation, according to an example embodiment of the present disclosure.

FIGS. 5-8 illustrate the torch system of FIG. 2 during different phases of a cutting operation, according to an example embodiment of the present disclosure.

FIG. 9 is a schematic-level block diagram of a fluid control system that may execute the techniques presented herein, according to another example embodiment of the present disclosure.

FIG. 10 is a schematic-level block diagram of a portion of a fluid control system that may execute the techniques presented herein, according to yet another example embodiment of the present disclosure.

FIG. 11 illustrates a hardware block diagram of a computing device that may operate the fluid control system presented herein in order to execute techniques presented herein, according to an example embodiment.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the techniques described herein provide precise, but inexpensive and uncomplicated, control of fluids for an arc processing system, such as an automated cutting or welding system. At a high-level, the fluid control system includes a manifold with two inlets and one or more outlets that direct fluid into a torch and/or toward a workpiece. Each inlet is connected to one of the outlets via a fluid line so that a first fluid line extends from the first inlet to the outlet and toward the workpiece and a second fluid line extends from the second inlet to the outlet (e.g., a different outlet, the same outlet) and toward the workpiece. Each line includes a one-way valve (e.g., a check valve) adjacent the inlet to prevent fluid that has entered the manifold via one of the inlets from exiting the manifold via either inlet. The check valves also serve a number of other functions, as is detailed below. Still further, the first fluid line is connected to the second fluid line by a share line that extends between the first fluid line and the second fluid line at a location disposed between the inlets and the outlet(s). The share line also includes a valve that is openable to allow fluid to flow from the first fluid line to the second fluid line or to allow fluid to flow from the second fluid line to the first fluid line. That is, the valve may selectively enable fluid flow between the first fluid line and the second fluid line. But, before describing this fluid control system in detail, the overall environment is briefly described to provide background for the fluid control system presented herein.

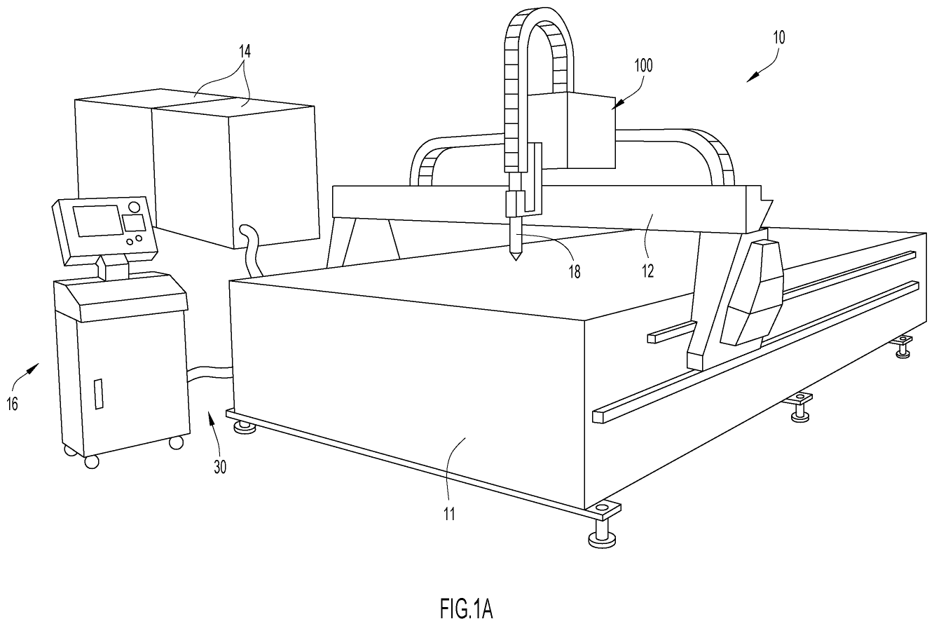

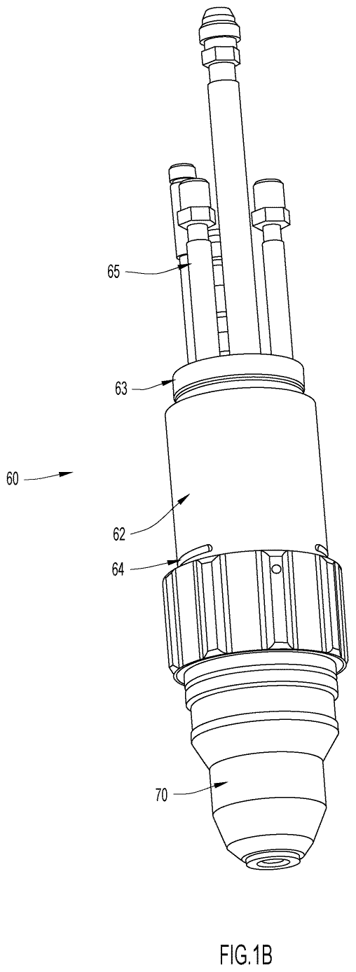

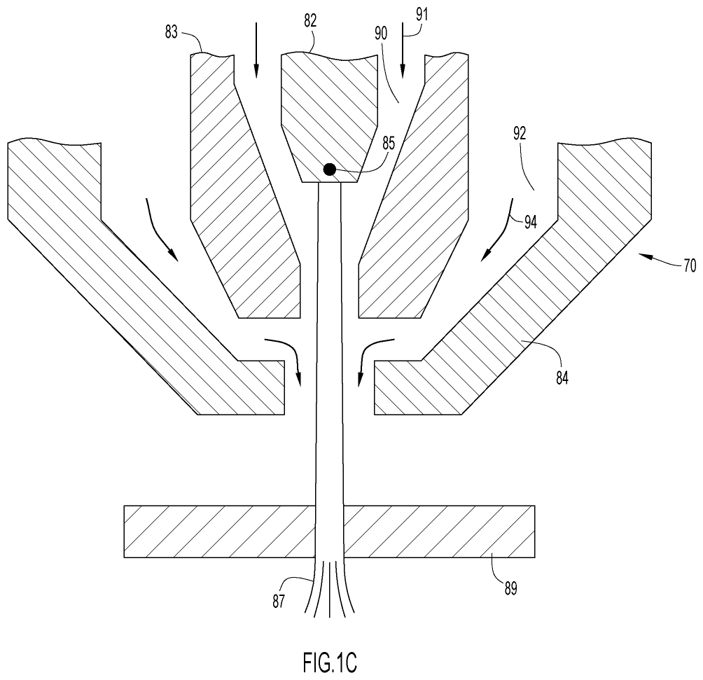

FIG. 1A illustrates an example embodiment of an automated cutting system 10 that may execute the techniques presented herein. However, this automated cutting system 10 is merely presented by way of example and the techniques presented herein may also be executed by manual cutting systems and/or automated cutting systems that differ from the automated cutting system 10 of FIG. 1A (e.g., any robotic or partially robotic cutting system). That is, the cutting system 10 illustrated in FIG. 1A is provided for illustrative purposes.

At a high-level, the cutting system 10 includes a table 11 configured to receive a workpiece (not shown), such as, but not limited to, sheets of metal. The automated cutting system also includes a positioning system 12 that is mounted to the table 11 and configured to translate or move along the table 11. At least one automated plasma arc torch 18 is mounted to the positioning system 12 and, in some embodiments, multiple automated plasma arc torches 18 may be mounted to the positioning system 12. The positioning system 12 may be configured to move, translate, and/or rotate the torch 18 in any direction (e.g., to provide movement in all degrees of freedom).

Additionally, at least one power supply 14 is operatively connected to the automated plasma arc torch 18 and configured to supply (or at least control the supply of) electrical power and flows of one or more fluids to the automated plasma arc torch 18 for operation. Also, a controller or control panel 16 is operatively coupled to and in communication with the automated plasma arc torch 18, the one or more power supplies 14, and the positioning system 12. The controller 16 may be configured to control the operations of the automated plasma arc torch 18, one or more power supplies 14, and/or the positioning system 12, either alone or in combination with the one or more power supplies 14. The controller 16 and power supply 14 may be fluidly and/or electrically connected to each other, the positioning system 12, and/or the plasma arc torch 18 via one or more conduits, leads, or cables 30.

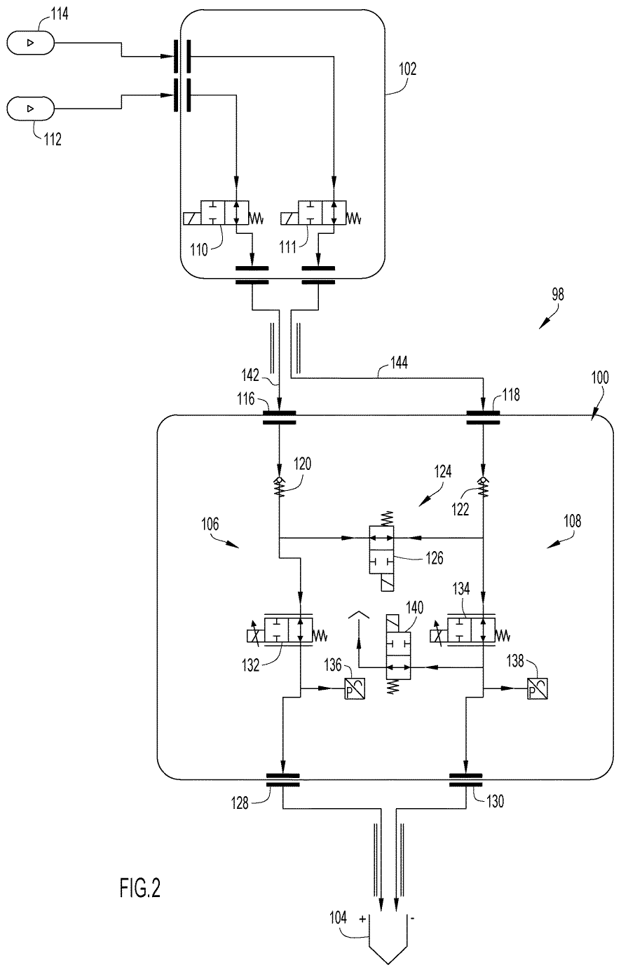

A fluid control system 100 controls the one or more flows of fluid to the automated plasma arc torch 18. The fluid control system 100 may include one or more cables 30, and one or more processors disposed in the controller 16 and/or the one or more power supplies 14. In some implementations, the fluid control system 100 may further include an electro-pneumatic regulator, one or more valves, one or more regulators, and the torch 18 (as is detailed below). Alternatively, one or more of the valves and/or the regulators may be disposed in the torch 18, and other components may be disposed in the one or more power supplies 14 and/or the controller 16. The fluid control system 100 is discussed in further detail below with reference to FIG. 2.

In at least some embodiments, the one or more power supplies 14 meter one or more flows of fluid received from one or more fluid supplies before or as the one or more power supplies 14 supply fluid to the torch 18 via the fluid control system 100. Additionally, or alternatively, the automated cutting system 10 may include a separate fluid supply unit (not shown) or units that can provide one or more fluids to the automated torch 18, via the fluid control system 100, independent of the one or more power supplies 14. To be clear, as used herein, the term “fluid” shall be construed to include a gas or a liquid. The one or more power supplies 14 may also condition, meter, and supply power to the automated torch 18 via the one or more cables 30, which may be integrated with, bundled with, or provided separately from cables 30 for fluid flows. Additional cables 30 for data, signals, and the like may also interconnect the controller 16, the automated plasma arc torch 18, the power supply 14, and/or the positioning system 12. Any cable 30 or cable conduit/hose/lead included in the automated cutting system 10 may be any length. Moreover, each end of any cable 30 or cable conduit/hose/lead may be connected to components of the automated cutting system 10 via any connectors now known or developed hereafter (e.g., via releasable connectors).

FIG. 1B illustrates an example embodiment of an automated cutting head 60 that may be used with an automated cutting system executing the techniques presented herein (e.g., the cutting system 10 of FIG. 1A). As can be seen, the cutting head 60 includes a body or torch body 62 that extends from a first end 63 (e.g., a connection end 63) to a second end 64 (e.g., an operating or operative end 64). The connection end 63 of the body 62 may be coupled (in any manner now known or developed hereafter) to an automation support structure (e.g., a cutting table, robot, gantry, etc., such as positioning system 12). Meanwhile, conduits 65 extending from the connection end 63 of the body 62 may be coupled to like conduits in the automation support structure (e.g., positioning system 12) to connect the automated cutting head 60 to the fluid control system 100 presented herein, a power supply, one or more fluid supplies, a coolant supply, and/or any other components supporting automated cutting operations.

At the other end, the operative end 64 of the body 62 may receive interchangeable components, including consumable components 70 that facilitate cutting operations. For simplicity, FIGS. 1A and 1B do not illustrate connections portions of the body 62 that allow consumable components 70 to connect to the torch body 62 in detail. However, it should be understood that the cutting consumables may be coupled to a torch body 62 in any manner. Moreover, to be clear, the consumable stack 70 depicted in FIG. 1B (with an external perspective view) is merely representative of a consumable stack that may be used with an automated torch executing the techniques presented herein. Similarly, while none of the Figures of the present application illustrates an interior of torch body 62, it is to be understood that any unillustrated components that are typically included in a torch, such as components that facilitate cutting operations, may be included in a torch executing example embodiments of the present application.

Now turning to FIG. 1C, this Figure is a simplified/schematic illustration of the consumable stack 70 of FIG. 1B. As mentioned, FIG. 1C only illustrates select components or parts that allow for a clear and concise illustration of the techniques presented herein. Thus, in FIG. 1C, only an electrode 82, a nozzle 83, and a shield cap 84 of the consumable stack 70 are depicted. As can be seen, the electrode 82 is disposed at a center of the consumable stack 70 and includes an emitter 85 (e.g., formed from hafnium, tungsten, and/or other emissive materials) at a distal end portion thereof. The nozzle 83 is generally positioned around the electrode 82. In some embodiments, the nozzle 83 is installed after the electrode 82. Alternatively, the electrode 82 and nozzle 83 can be installed onto the torch body 62 as a single component (e.g., these components may be coupled to each other and installed on/in the torch body collectively). In either case, the nozzle 83 may be spaced from the electrode 82; or at least a distal portion of the nozzle 83 may be spaced apart from the distal portion of the electrode 82.

The shield 84 is positioned radially exteriorly of the nozzle 83 and is spaced apart from the nozzle 83, at least at its distal end. In some embodiments, the shield 84 is installed around an installation flange of the nozzle 83 in order to secure nozzle 83 and electrode 82 in place at (and in axial alignment with) an operating end of the torch body. Additionally or alternatively, the nozzle 83 and/or electrode 82 can be secured or affixed to a torch body in any desirable manner, such as by mating threaded sections included on the torch body with corresponding threads included on the components. For example, in some implementations, the electrode 82, nozzle 83, shield 84, as well as any other components (e.g., a lock ring, spacer, secondary cap, etc.) may be assembled together in a cartridge that may be selectively coupled to the torch body (e.g. by coupling the various components to a cartridge body or by coupling the various components to each other).

In use, a plasma torch is configured to emit a plasma arc 87 between the electrode 82 and a workpiece 89 to which a work lead associated with a power supply is attached (not shown). As shown in FIG. 1C, the nozzle 83 is spaced a distance away from the electrode 82 so that a plasma gas flow channel 90 is disposed therebetween. During piercing and cutting operations, a plasma gas 91 flows through the plasma gas flow channel 90. The shield 84 is also spaced a distance away from the nozzle 83 so that a shield flow channel 92 is disposed between the shield 84 and the nozzle 83. A shield fluid 94 flows through the shield flow channel 92 during at least a portion of the time the torch is operated.

The present disclosure is related to controlling flow of the plasma gas 91 and/or of the shield fluid 94. For example, respective lines may direct the plasma gas 91 and the shield fluid 94 toward the workpiece 89, and a share line may be used to transfer fluid between the lines. By operating the share line to selectively adjust the flow of the plasma gas 91 and/or of the shield fluid 94, a flow rate and/or pressure of the plasma gas 91 and/or of the shield fluid 94 may be acutely controlled. Consequently, cutting operations may be more desirably provided (e.g., by adjusting how the plasma arc 87 is generated and transferred to the workpiece 89).

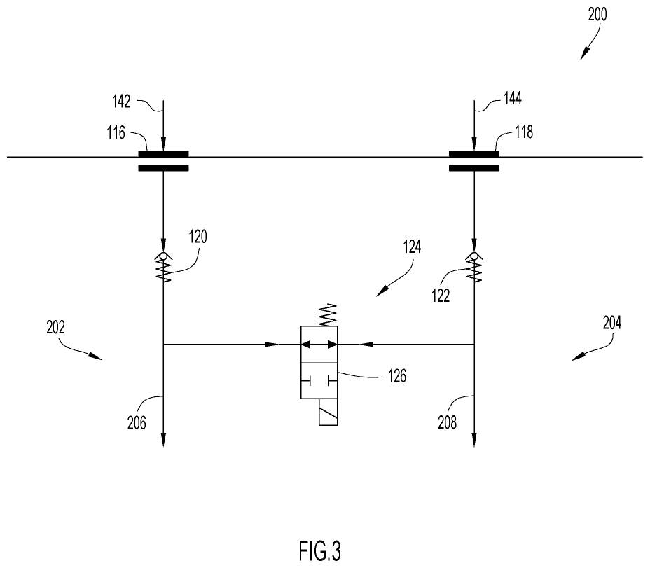

Now referring to FIGS. 2 and 3 for a description of an exemplary embodiment of a torch system 98 (e.g., an arc processing system) that includes a fluid control system 100 (e.g., a remote gas controller) for controlling fluid(s) for an arc process torch (e.g., torch 18 of FIG. 1A). The fluid control system 100 is generally positioned between a power supply 102 and a torch 104 (e.g., a torch body, a torch consumable), but proximate the torch 104. Thus, two lines 106, 108 extend from the power supply 102 to the fluid control system 100. At the power supply 102, each line 106, 108 may be controlled and/or metered by a respective supply valve 110, 111, such as a solenoid valve. As shown, the fluid in each line 106, 108 may be provided from fluid supplies 112, 114 that are provided separately from the power supply 102. The first line 106 may be dedicated to a first function and the second line 108 may be dedicated to a second function. For example, in the depicted embodiment, the first line 106 provides shield fluid for the torch 104 and the second line 108 provides plasma/cutting fluid for the torch 104. However, in other embodiments, the lines 106, 108 may be used for any desired functions. In any case, the lines 106, 108 do not run directly from the power supply 102 to the torch 104; the lines 106, 108 run to the fluid control system 100.

The fluid control system 100 includes two inlets—a first inlet 116 for the first line 106 and a second inlet 118 for the second line 108 of the depicted embodiment—and each inlet 116, 118 has a one-way valve, a first one-way valve 120 controlling flow through the first line 106 and a second one-way valve 122 controlling flow through the second line 108. In the depicted embodiment, the one-way valves 120, 122 are double biased check valves, as is explained in further detail below. The fluid control system 100 also includes two outlets—a first outlet 128 for the first line 106 and a second outlet 130 for the second line 108. The first one-way valve 120 enables fluid flow away from the first inlet 116 (e.g., toward the first outlet 128) while blocking fluid flow toward the first inlet 116, and the second one-way valve 122 enables fluid flow away from the second inlet 118 (e.g., toward the second outlet 130) while blocking fluid flow toward the second inlet 118.

Critically, the first line 106 and the second line 108 are connected to each other via a share line 124 that includes a share valve 126. In the depicted embodiment, the share valve 126 is a two-state (e.g., on-off) solenoid valve, but the share valve 126 may take other forms in other embodiments. In an open position, the share valve 126 enables fluid flow through the share line 124, between lines 106, 108. In a closed position, the share valve 126 blocks fluid flow through the share line 124, thereby fluidly isolating the lines 106, 108 from one another. The share valve 126 may also be set in an intermediate position (e.g., a partially open position, a partially closed position) to enable some, but not full, fluid flow through the share line 124 and between the lines 106, 108. Portions (e.g., upstream portions or inlet portions extending from the inlets 116, 118) of the first line 106 and the second line 108 are depicted with the share line 124 in detail in FIG. 3. This portion of the fluid control system 100 may be referred to herein as the share assembly. The share assembly is critical to allowing the fluid control system 100 to provide a wide variety of functions with precise control.

As is shown in FIG. 2, the first line 106 of the fluid control system 100 and the second line 108 of the fluid control system 100 each have a respective restrictable orifice (e.g., at downstream portions or outlet portions extending from the outlets 128, 130) in the form of a proportional flow valve 132, 134. Then, a respective pressure sensor 136, 138 is positioned on the lines 106, 108 between the first outlet 128 and the proportional flow valve 132 or between the second outlet 130 and the proportional flow valve 134. As further discussed herein, the pressure sensors 136, 138 determine pressure of the fluid (e.g., of shield fluid, of plasma fluid) within each line 106, 108 at or near outlets 128 and 130. The fluid control system 100 may operate based on the determined pressures to provide desirable operation of the torch 104.

In at least some embodiments, the pressure sensors 136, 138 are configured to recalibrate to atmospheric pressure during each initiation phase of fluid control system 100 and/or the power supply 102. This is to mitigate any location or elevation dependent variances in process pressure setpoints, and to mitigate flow variance across locations of different elevation. To this end, the supply valves 110, 111 are both shut during startup, and the valves 126, 132, 134, as well as a vent valve 140 that discharges fluid from the second line 108 (e.g., from downstream of the proportional flow valve 134 to an ambient environment) and away from the outlets 128, 130, in the fluid control system 100 are opened. With both proportional flow valves 132, 134, the share valve 126, and the vent valve 140 open, both lines 106, 108 are coupled and equilibrated to atmospheric pressure, and each pressure sensor 136, 138 is calibrated using this as its 0 psi gauge pressure, from which all the rest of the setpoint pressures are measured from.

This arrangement of valves 126, 132, 134, 140 and pressure sensors 136, 138 is merely an example, and other embodiments of fluid control system 100 may include any arrangement of sensors and/or valve (e.g., between the share line 124 and either outlet 128, 130). Additionally or alternatively, other embodiments of the fluid control system 100 may form restrictable orifices on the first line 106 and/or the second line 108 between the share line 124 and either inlet 116, 118 (e.g., between the share line 124 and the first one-way valve 120, between the share line 124 and the second one-way valve 122) in any manner, e.g., with or without a proportional flow valve. In any case, the fluid control system 100 discharges fluid via the outlets 128, 130 and to the torch 104 to provide at least two lines of fluid—e.g., plasma/cutting fluid and shield fluid—for the torch 104. In some embodiments, the first line 106 and/or second line 108 extend beyond the fluid control system 100 and extend directly into the torch 104. However, in other embodiments, the first line 106 and/or the second line 108 extend to fittings that connect the first line 106 and/or the second line 108 to a torch lead that directs fluid(s) into the torch 104. In other words, the first line 106 and/or the second line 108 may terminate prior to the torch 104.

FIG. 3 is a detail view of a portion of the fluid control system 100 of FIG. 2, specifically illustrating a share assembly 200 that includes the share line 124, an upstream portion 202 (e.g., an inlet/intake portion) of the first line 106, and an upstream portion 204 (e.g., an inlet/intake portion) of the second line 108. The upstream portion 202 is connected to the first inlet 116, extends to the proportional flow valve 132 (FIG. 2), and includes the first one-way valve 120, and the upstream portion 204 is connected to the second inlet 118, extends to the proportional flow valve 134 (FIG. 2), and includes the second one-way valve 122. The share line 124 is connected to the upstream portion 202 between the first one-way valve 120 and the proportional flow valve 132, and the share line 124 is connected to the upstream portion 204 between the second one-way valve 122 and the proportional flow valve 134. Thus, the share line 124 may direct fluid (e.g., shield fluid) from the first one-way valve 120 to the upstream portion 204 and/or direct fluid (e.g., plasma fluid) from the second one-way valve 122 to the upstream portion 202.

As mentioned, in the depicted embodiment, the one-way valves 120, 122 are double biased check valves. These valves are biased closed by a spring force/pressure to prevent or at least discourage a fluid from flowing from the power supply 102 (FIG. 2), such as via respective supply lines 142, 144 extending between the power supply 102 and fluid control system 100 and fluidly coupling the respective lines 106, 108 to the power supply 102, to the fluid control system 100 (e.g., flowing in a positive direction) until a predetermined amount of fluid pressure has built in the supply line to provide a force that overcomes the spring force to open the valve. Consequently, the one-way valves 120, 122 ensure that a fluid flow enters the fluid control system 100 at a minimum pressure while eliminating backwards flows (e.g., toward the inlets 116, 118 within the fluid control system 100) that might create detrimental flow conditions or safety concerns. In turn, this allows the fluid control system 100 to provide smooth, low latency, remote switching between supply fluids without need for active or proportional control, as is detailed further below. Instead, selective, discrete control of two supply solenoids at the power supply 102 can control fluid flow into the fluid control system 100 at a large distance from the point of transition, avoiding issues caused by EMI interference, while still providing remote switching. That is, each of the supply valves 110, 111 at the power supply 102 can be controlled based on the respective cracking pressures of the one-way valves 120, 122 (i.e., fluid pressure that opens a corresponding one of the one-way valves 120, 122 to enable subsequent fluid flow therethrough) to control when a fluid is introduced into fluid control system 100.

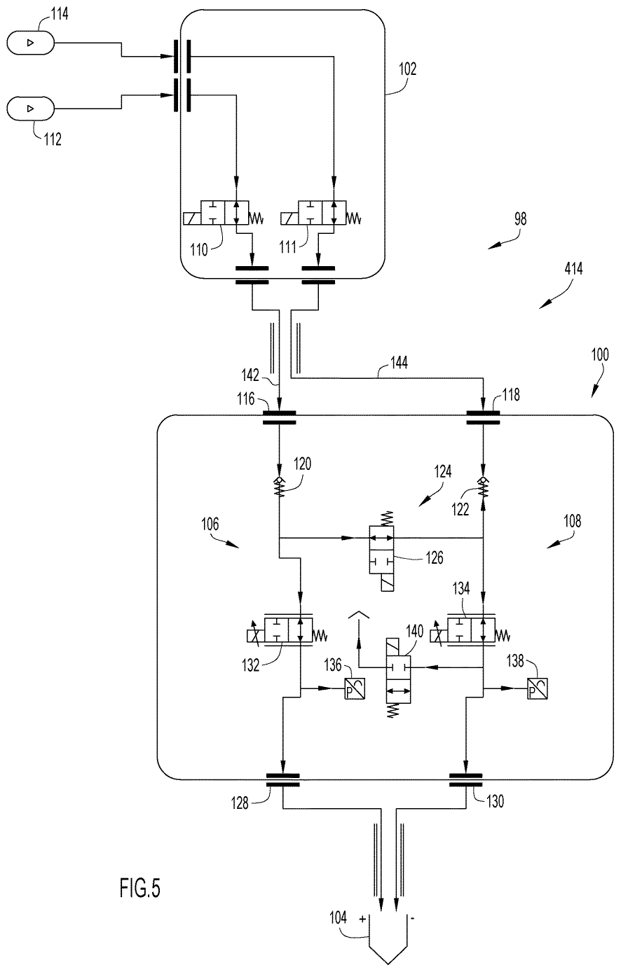

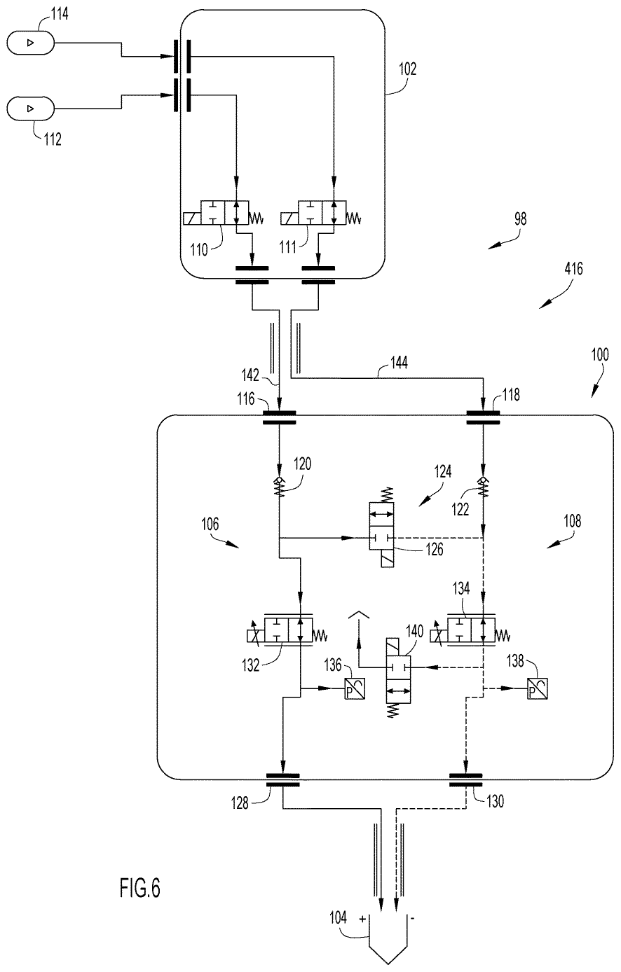

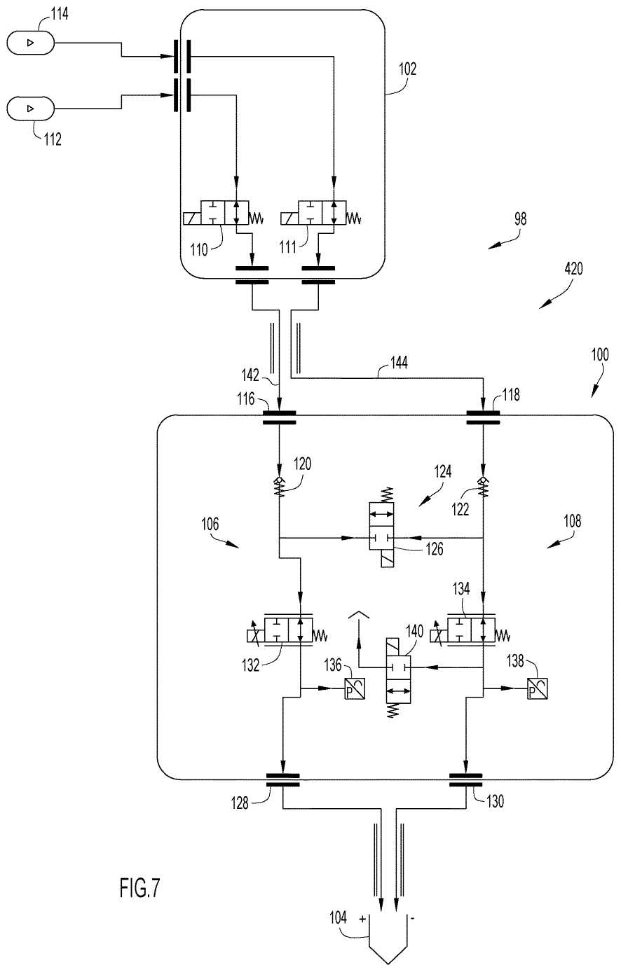

At the same time, the share valve 126 (e.g., a single solenoid valve) can be utilized to control how fluid entering the fluid control system 100 flows through the fluid control system 100. The position of the share valve 126 might also impact the cracking pressure of one or both one-way valves 120, 122, and the valve control at the power supply 102 can be adjusted accordingly. More specifically, there are four possible flow states/configurations in the illustrated embodiment. First, the share line 124 is closed to block fluid flow between the lines 106, 108. Consequently, fluid (e.g., shield fluid) entering at the first inlet 116 can flow to a first point 206 (e.g., intake at the first proportional flow valve 132) of the first line 106 while fluid (e.g., plasma fluid) entering at the second inlet 118 flows to a second point 208 (e.g., intake at the second proportional flow valve 134) of the second line 108. Such a flow state is further illustrated and described with respect to FIG. 7. Second, the share line 124 is open to enable fluid flow between the lines 106, 108, and fluid (e.g., shield fluid) entering at the first inlet 116 can flow to both points 206, 208. Such a flow state is further illustrated and described with respect to FIGS. 5 and 6. Third, the share line 124 is open to enable fluid flow between the lines 106, 108, and fluid (e.g., plasma fluid) entering at the second inlet 118 can flow to both points 206, 208. Fourth, and finally, there can be no fluid entering at the inlets 116, 118. To achieve these four states, an system controller (e.g., an automation controller, a programmable controller, a cloud computing device, a processor, processing circuitry) would place the share valve 126 and the two supply valves 110, 111 at the power supply 102 in the following states, with 1 indicating an open position to allow fluid flow therethrough and 0 indicating a closed position to block fluid flow therethrough:

| | Shield | Plasma | |
|---|---|---|---|
| STATE | Supply | Supply | Share |
| 1 | 1 | 1 | 0 |
| 2 | 1 | 0 | 1 |
| 3 | 0 | 1 | 1 |
| 4 | 0 | 0 | 0 |

As an example, if the system starts in state 4, both supply valves 110, 111 at the power supply 102 are closed to block fluid flow out of the power supply 102, and, as a result, no fluid is flowing through the fluid control system 100. In the table above, state 4 indicates that the share valve 126 would also be closed. However, in some embodiments, the share valve 126 is open without affecting fluid flow through the fluid control system 100 (e.g., because there is no fluid within the fluid control system 100). In additional or alternative embodiments, even though the supply valves 110, 111 are closed to block fluid flow into the fluid control system 100, there may still be some residual fluid within the fluid control system 100. In such embodiments, it may be beneficial to keep the share valve 126 in a particular position (e.g., a closed position) to direct such fluid out of the fluid control system 100 in a desirable manner (e.g., via purging or cleaning techniques).

In any case, to move from state 4 to state 2, the system controller opens the share line 124 and the supply valve 110 connected to the first line 106. Consequently, fluid (e.g., shield fluid) flows into the fluid control system 100 via the first inlet 116 and to the first one-way valve 120. After some amount of ramp time, which may depend on at least the distance between the supply valves 110 and the fluid control system 100, the fluid causes the first one-way valve 120 to open. Consequently, the fluid flows from the first one-way valve 120, away from the first inlet 116, and apportions between flowing to the first point 206 or through the share line 124 and to the second point 208. At the same time, the second one-way valve 122 prevents or at least discourages back flow of fluid from the upstream portion 204 to the second inlet 118, thereby forcing fluid flow through the upstream portion 204 toward the second point 208. Once at steady state fluid flow at both points 206, 208, the fluid control system 100 has reached state 2 in which fluid is discharged from the fluid control system 100 toward the torch 104 via the first line 106 and fluid exerts an internal force/pressure against the second one-way valve 122 and further urges the second one-way valve 122 to close, supplementing the baseline biasing pressure that urges the second one-way valve 122 closed.

Once at steady state in state 2, the other supply valve 111 (at the power supply 102) can be opened to allow fluid (e.g., plasma fluid) to the second inlet 118, allowing pressure to naturally ramp up in the supply line to the second inlet 118 and against the second one-way valve 122. Because fluid inside of the fluid control system 100 exerts an internal pressure against the second one-way valve 122 in state 2, the cracking pressure of the second one-way valve 122 is increased. That is, a greater amount of pressure needs to be exerted on one-way valve 122 to open the second one-way valve 122 in state 2 as compared to the amount of pressure to be exerted to open the second one-way valve 122 in state 1 (i.e., in which the share valve 126 is closed such that second one-way valve 122 is urged to close via a biasing pressure without fluid-induced internal pressure). Therefore, state 2 may be used to control the pressure in which fluid from the supply valve 111 ultimately opens the second one-way valve 122 to enable subsequent fluid flow therethrough.

In certain embodiments, the supply valve 111 can be carefully controlled based on at least the state of the supply valve 110 (and potentially based on pressures detected at fluid control system 100 as well) to precharge the supply line 144 without opening the second one-way valve 122. Alternatively, the supply valve 111 can be carefully controlled to overcome the biasing pressure of the second one-way valve 122 plus the internal pressure acting on the second one-way valve 122 to enable fluid flow from the respective supply lines 144 through the second one-way valve 122 and away from the second inlet 118, thereby transitioning the fluid control system 100 out of state 2.

For example, the supply valves 110 can be carefully controlled to transition the fluid control system 100 from state 2 to state 1. During such a transition state, the share line 124 is not immediately closed; instead, the share line 124 is closed when the fluid control system 100 reaches steady state fluid flow at both points 206, 208 (see FIG. 6). Advantageously, since the share line 124 is left open while pressure increases at respective supply lines 144 to overcome the biasing pressure and internal pressure, the second one-way valve 122 will act to allow partial pressure mixing of the fluid from both lines 106, 108 (e.g., adjacent to the second point 208). This transition state will be naturally non-impulsive (i.e., without a sudden change in pressure) at the second point 208, because the partial pressure mixing is effectuated by the natural ramp up of pressure in the respective supply lines 142, 144. That is, because pressurized fluid is present downstream of the second one-way valve 122 (i.e., within the fluid control system 100) prior to opening the second one-way valve 122, pressurized fluid at both sides of the second one-way valve 122 will mix with one another upon opening the second one-way valve 122. In other words, there is a relatively low fluid pressure differential at opposite sides of the second one-way valve 122 prior to the second one-way valve 122 opening. This contrasts with an example in which fluid is pressurized against a side of a valve (e.g., an on/off solenoid valve) that is forced closed (e.g., via an absence of a control signal) without there being fluid or other source exerting pressure against an opposite side of the valve. In such an example, when the valve is eventually opened (e.g., forced open via a control signal), there is a relatively high pressure differential at opposite sides of the valve, which causes a sudden influx of pressure to occur on opening the valve, creating an elevated pressure impulse.

To terminate the transition state after a set period of time predetermined by this natural ramp time (governed again by the distance and fluid conductivity of the supply lines 142, 144 between the fluid control system 100 and the supply valves 110, 111), the share valve 126 will be switched off to establish the fluid control system 100 in state 1. Consequently, fluid between the lines 106, 108 no longer mix, resulting in the first point 206 including fluid (e.g., shield fluid) from the supply line 142 and not fluid (e.g., plasma fluid) from supply line 144 while the second point 208 includes fluid (e.g., plasma fluid) from the supply line 144 and not fluid (e.g., shield fluid) from the supply line 142. That is, with the share valve 126 closed and both supply valves 110, 111 opened as shown in state 1, one fluid flows from the first inlet 116 to first point 206, and another fluid separately and independently flows from the second inlet 118 to the second point 208 (see FIG. 7).

To switch from state 1 to state 2 or state 3, again without pressure impulse, one of the supply valves 110, 111 is closed, and the share line 124 is opened, either simultaneously or within a short duration of time. Then, the corresponding point 206, 208 aligned with the closed supply valve 110, 111 (the first point 206 is aligned with the supply valve 110 and the second point 208 is aligned with the supply valve 111) will adopt/receive fluid from the open supply valve 110, 111 in accordance with the natural pressure evolution/propagation in both lines 106, 108. For example, if the supply valve 111 is closed while the supply valve 110 and the share valve 126 are opened to move the system into state 2, fluid (e.g., shield fluid) from the supply valve 110 will flow to the first inlet 116, and fluid will flow from the first inlet 116 to both the first point 206 and the second point 208 in accordance with the natural pressure evolution in both lines 106, 108.

In sum, the fluid control system 100 can transition between different states and passively adjust fluid flow through the fluid control system 100 via natural fluid pressure evolution without having to actively/positively control and redirect fluid flow. This passive control is very low impulse (e.g., because of the natural pressure buildup and release by the one-way valves 120, 122) compared to the traditional method of simply opening and closing multiple different selection valves (e.g., on/off valves). The transfer is smooth, allowing for natural mixing between fluids during transition, and response time is also almost immediate given the proximity of the share valve 126 to the points 206, 208. Thus, the share assembly 200 of the fluid control system 100 provides seamless dynamic control over both fluid selections without any necessity for sensors or active control (but, to be clear, the fluid control system 100 might also incorporate active control and sensors, such as for redundancy in control).

Still referring to FIG. 3, as was alluded to above, the share assembly 200 of the fluid control system 100 also allows for partial pressure gas mixing. That is, the share line 124—as arranged in the share assembly 200 of the fluid control system 100—allows the fluid control system 100 to provide a mixed fluid output on one or both lines 106, 108 (while also allowing specific fluids to be selected for one or both lines 106, 108). In fact, the share assembly 200 creates multiple options for implementing volumetric fluid mixing by partial pressures during steady state flow. However, techniques that enable mixing while still allowing the fluid control system 100 to move between a shared output selection or unique output selections (i.e., states 1, 2, and 3) may be preferred.

As a first example of mixing, each of the supply pressures at the power supply 102 can be manipulated (e.g., controlled by a system controller) to provide dynamic supply pressures while holding the share line 124 open. Then, steady state flows can smoothly transition to volumetric mixing percentages by controlling a pressure difference between the supply lines 142, 144. If the valve flow coefficient (Cv) of the supply lines 142, 144 between the power supply 102 and fluid control system 100 are much higher than that of the supply valves 110, 111 at full open, the losses can be assumed approximately equal for both supply lines 142, 144, making the inlet pressures at the inlets 116, 118 directly proportional to the individual supply pressures. The volumetric mixing percentages of the fluids will be proportional to the relative pressures of the fluids. The line in which fluid mixture occurs may be the line 106, 108 receiving fluid having the lower of the two supply pressures.

As another option, mixing can be controlled by pulse width modulating the supply valves 110, 111 while keeping the supply pressures equal. This allows for any of the previously discussed steady flow states at the points 206, 208, as well as selective controlled mixing by the same partial pressure principal. But, now the differential supply pressure is set by a single pulse width modulated supply valve instead of a difference in overall pressure between the two lines 106, 108. With the fluid control system 100 presented herein, the fluid control system 100 may be far enough away from the power supply 102 (where the pulse modulated valve is disposed) to allow full pressure pulse dampening by the time pulse modulated fluids reach the inlets 116, 118 of fluid control system 100. Thus, the pulse width modulation has the overall effect of changing the pressure of the fluid supply and will function in the same manner as the first example, but without requiring a change in supply pressure (e.g., via the supply valves 110, 111). Thus, with this option, the mixing may be dynamically controlled without having to control supply pressures at the power supply 102 (e.g., via a system controller).

Notably, in conventional systems, pulse width modulating a solenoid valve for mixing can be problematic because it can be difficult to achieve the necessary switching frequency on the solenoid valve that provides a homogenous gas mixture at output. However, here, long lead length between the power supply 102 and fluid control system 100 allows lower switching frequency to still achieve sufficient fluid homogeny at the point of use. This is because the fluids naturally mix along the length of the lines 142, 144, 106, 108, and/or lines between fluid control system 100 and the torch 104. The share valve 126 also assists in remedying conventional issues because the pressure differential across the share valve 126 governs the mixing direction and volumetric ratio. In some instances, the effects of the pressure differential on mixing direction and volumetric ratio can be determined empirically. Alternatively, some embodiment may add pressure sensors to the fluid control system 100 to produce a very accurate gas mixing control, and perhaps a dynamic control. In any case, the dampening effect from the lead length allows supply pressure to remain sufficiently smooth at the fluid control system 100 even with low switching frequencies. This extends the valve life and allows use of much less expensive valves (e.g., valves that do not have to accommodate the desirable switching frequency) than the average mixing operation. That said, the necessary switching frequency will depend on the lead length, the mixing ratio, and the pulse width modulation duty cycle associated with that ratio.

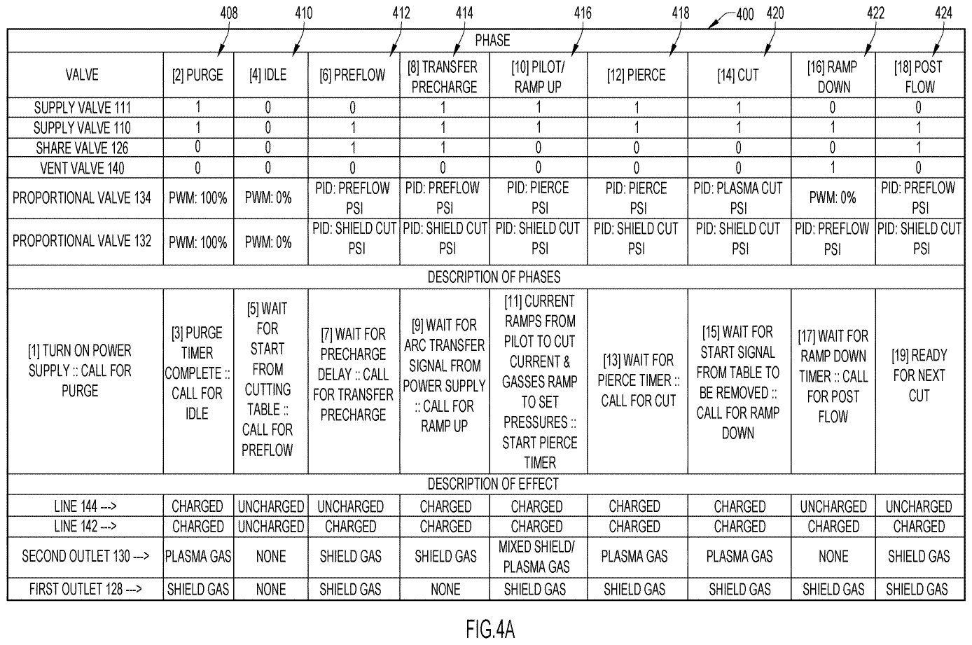

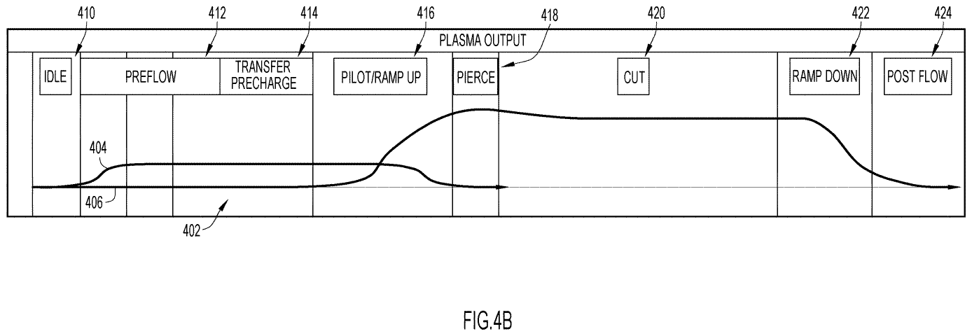

Now turning to FIGS. 4A and 4B, when the fluid control system 100 shares one supply gas amongst two separate lines 106, 108 (e.g., states 2 and 3), this creates a dependency between the two lines 106, 108. Thus, if each line 106, 108 has a restrictable orifice, such as the proportional flow valves 132, 134, that allows the output of each line 106, 108 to be independently controlled, one control response will affect the other, inducing a response in the other. By comparison, in conventional systems that include independent valves and regulators for independent lines, each valve and regulator can be controlled at-will without worrying about the other lines. Thus, from some perspectives, the share valve 126 of the present application creates adverse conditions. These adverse conditions are a significant problem since consumable life of arc process torches is often highly dependent on a smoothness of gas transitions and pressure gradients.

As a more specific example, when the fluid control system 100 is used for a plasma cutting operation and moves into state 2 (share valve 126 and supply valve 110 open, e.g., to provide shield gas to both points 206, 208), the supply line 142 is being shared between both the lines 106, 108. Thus, a quick response on one of the proportional flow valve 132, 134 in the fluid control system 100 (for example, a sudden change in set pressure on the first line 106) could produce unwanted and impactful fluid dynamical impulses at the second line between the second one-way valve 122 and the proportional flow valve 134, causing interplay and possible control oscillation with two active controls (one for the first line 106 and another for the second line 108), continually and alternately responding to the actions of one another. This impulse would inevitably perturb the fluid control system 100, goading an otherwise unnecessary response and sometimes a noticeable impulse on the plasma output.

To mitigate this issue, the fluid control system 100 may precisely control when the share valve 126 is open, in a manner unique to the particular arrangement of the share assembly 200 of fluid control system 100. For example, during very sensitive times in the cut routine (e.g., during arc transfer, ramp up, and ramp down), the shield fluid pressure might be set at a setpoint under active control and then be held at this point via open loop control (disregarding the error accumulated between output pressure and set pressure) until the plasma fluid pressure has reached steady state. Then, closed loop control can be initiated on the shield line (e.g., the first line 106) under slightly different PID (proportional, integral, derivative) parameters in order to slowly settle into its anticipated setpoint without affecting the output of the plasma line (e.g., the second line 108), or until fluid sharing is finished and the lines 106, 108 are no longer coupled fluidically. This is shown in the valve state table of FIG. 4A as direct PWM (pulse width modulation) and active PID control. PWM is measured in a percentage or a duty cycle, and the PID is measured in its setpoint. By integrating this interplay into the control of the fluid control system 100, the control authority will favor the more sensitive line 106, 108 when the shared state is active (i.e., when the share valve 126 is open). In most automated cutting scenarios, the plasma output line (e.g., the second line 108) has been found to be the more sensitive line.

To be clear, in FIG. 4A, the PWM is directed to valves inside the fluid control system 100. Thus, on one hand, PWM of the supply valves 110, 111 enables volumetric gas mixing while on the other hand, PWM of valves inside the fluid control system 100 may enable control of multiple connected lines.

More specifically, FIG. 4A includes a table 400 describing the configuration/position of various components of the fluid control system 100 in different phases/stages (e.g., operational phases) of the torch system 98 for a cutting operation. FIG. 4B includes a graph 402 illustrating the flow rate of different fluids directed through the fluid control system 100 (e.g., through the second line 108) at different phases. FIGS. 4A and 4B will be discussed together.

A first graph line 404 of the graph 402 corresponds to shield fluid, and a second graph line 406 of the graph 402 corresponds to plasma fluid. In some embodiments, the torch system 98 progresses through the various phases in response to a signal, such as that provided by the power supply 102, a cutting table (e.g., the table 11), and/or one or more a system controllers. In additional or alternative embodiments, the torch system 98 progresses through the phases in response to elapse of a duration of time, as indicated by a timer.

In at least some instances, the cutting operation may initiate upon turning on the power supply 102 to start a purge phase 408. During the purge phase 408, the share valve 126 and the vent valve 140 are closed, and the supply valves 110, 111 are open. Consequently, the supply valve 110 directs shield fluid to the first one-way valve 120, and shield fluid flows from the first one-way valve 120 to the first outlet 128. Meanwhile, the supply valve 111 directs plasma fluid to the second one-way valve 122, and the plasma fluid flows from the second one-way valve 122 to the second outlet 130. Such flow of shield fluid and plasma fluid through the fluid control system 100 may remove unwanted residual fluid and/or debris from any fluid paths in the torch system 98, such as from both lines 106, 108 and/or from different parts of the torch 104 (e.g., shield and plasma flow paths). During the purge phase 408, the proportional flow valves 132, 134 are controlled at 100% duty cycle PWM (e.g., 750,000 Pascal (Pa) or 110 pounds per square inch (psi)), which may enable full flow of the shield fluid flow to the outlets 128, 130. For brevity, the purge phase 408 is not shown in the graph 402.

After the purge phase 408 has been completed, such as after a threshold duration of time has elapsed since initiation of the purge phase, an idle phase 410 begins. During the idle phase 410, each of the valves 110, 111, 126, 140 are closed, and the proportional flow valves 132, 134 are operated at 0% duty cycle PWM. Thus, there is little or substantially no fluid flow through the fluid control system 100. This may essentially reset the fluid control system 100 after the purge phase 408.

Upon completion of the idle phase 410, a preflow phase 412 initiates by opening the supply valve 110 and the share line 124. As a result, shield fluid is directed into the fluid control system 100 to the lines 106, 108. Additionally, the proportional flow valve 134 is operated via PID control. Operation of the proportional flow valve 134 via PID control helps regulate shield fluid flow through the second line 108 toward the second outlet 130. For instance, the proportional flow valve 134 is operated to block some shield fluid flow toward the second outlet 130, thereby forcing shield fluid toward the second one-way valve 122 instead. Consequently, shield fluid provides an internal pressure against the second one-way valve 122, thereby urging the second one-way valve 122 to close (e.g., by supplementing a biasing pressure of the second one-way valve 122) and establishing a new, increased target/desirable cracking pressure of the second one-way valve 122. That is, the supply valve 110 and the proportional flow valve 134 are cooperatively operated to direct shield fluid into the fluid control system 100 (e.g., at a particular flow rate, at a particular pressure) to establish the new, increased target cracking pressure of the second one-way valve 122. Additionally or alternatively, the proportional flow valve 132 is operated via PID control to enable some fluid flow to the first outlet 128. The preflow phase 412 may be completed upon establishing the new, increased target cracking pressure of the second one-way valve 122.

After the preflow phase 412 is completed, a transfer precharge phase 414 (e.g., a pilot ignition phase) initiates by opening the supply valve 111, thereby directing plasma fluid to the fluid control system 100. The supply valve 110 and the share valve 126 remain open during the preflow phase 412, and the proportional flow valves 132, 134 continue to be operated via PID control. Thus, the fluid control system 100 continues to operate to direct shield fluid against the second one-way valve 122 to maintain the target cracking pressure of the second one-way valve 122. For this reason, although plasma fluid is directed to the second one-way valve 122 via the supply valve 111, the second one-way valve 122 remains closed, thereby blocking plasma fluid flow through the fluid control system 100. Instead, plasma fluid pressurizes at the second one-way valve 122 (e.g., between the second inlet 118 and the second one-way valve 122, at the supply line 144).

A pilot/ramp up phase 416 (e.g., an arc generation phase, a pilot cut gas advance phase) occurs after the transfer precharge phase 414. During the pilot/ramp up phase 416, the supply valve 111 remains open to continue to direct plasma fluid to the second one-way valve 122, while the supply valve 110 remains open to continue to direct shield fluid to the first one-way valve 120. However, the share valve 126 closes to block the shield fluid from flowing to the second one-way valve 122, thereby preventing or at least discouraging the shield fluid from further increasing the cracking pressure of the second one-way valve 122. Consequently, the plasma fluid continues to pressurize at the second one-way valve 122 and eventually overcomes the cracking pressure of the second one-way valve 122, thereby opening the second one-way valve 122. Accordingly, plasma fluid flows through the second line 108 via the opened second one-way valve 122, and the plasma fluid mixes with the shield fluid in the second line 108 to flow to the second outlet 130. Because the plasma fluid was pressurized to a pressure above a baseline cracking pressure of valve 122 (e.g., the cracking pressure required to overcome an internal biasing pressure of valve 122) prior to entering the fluid control system 100, the plasma fluid may flow through the second line 108 at an elevated pressure and/or flow rate upon opening of the second one-way valve 122 when the second one-way valve 122 eventually opens. For example, immediately after the second one-way valve 122 opens, the pressure of the plasma fluid may be at a similar pressure as that of the shield fluid providing the internal pressure against the second one-way valve 122. Therefore, plasma fluid and shield fluid at substantially similar pressures mix with one another to reduce a pressure impulse when the second one-way valve 122 opens.

Additionally, during the ramp up phase 416, current is provided to the torch 104 to generate an arc within the torch 104. The plasma fluid urges the arc to strike and to transfer out of the torch 104 and to a workpiece at the transfer precharge phase 414. Specifically, the elevated pressure of the plasma fluid, as effectuated by the target cracking pressure of the second one-way valve 122, may more readily transfer the arc to the workpiece, such as within a threshold duration of time upon generation of the arc. Transferring the arc to the workpiece within the threshold duration of time limits contact between the arc and another component of the torch 104, thereby maintaining a structural integrity of the torch 104 and prolonging a useful lifespan of the torch 104 and/or consumables attached thereto. In other words, the fluid control system 100 controls shield fluid to establish the target cracking pressure of the second one-way valve 122 such that plasma fluid sufficiently pressurized to overcome the increased target cracking pressure will transfer the generated arc, such as without having to further ramp the pressure of the plasma fluid within the second line 108 (e.g., to cause the generated arc to remain within the torch 104 instead of being transferred to the workpiece as the pressure is ramped). In some embodiments, the PID control of the proportional flow valve 134 is also adjusted to provide the plasma fluid at a sufficient pressure and/or flow rate to transfer a generated arc to the workpiece. Moreover, the proportional flow valve 132 continues to operate via PID control at the ramp up phase 416 to direct shield fluid through the first line 106, to the first outlet 128, and to the torch 104. Thus, the fluid control system 100 readily directs the shield fluid to the torch 104 when an arc is generated such that the shield fluid helps maintain the arc (e.g., by shielding the arc from an external environment).

A pierce phase 418 occurs after the pilot/ramp up phase 416 by closing the share valve 126 to block shield fluid flow to the second line 108. Consequently, shield fluid and plasma fluid no longer mix within the fluid control system 100. In other words, shield fluid, and not plasma fluid, flows through the first line 106, whereas plasma fluid, and not shield fluid, flows through the second line 108. In some embodiments, respective PID control of the proportional flow valves 132, 134 from the pilot/ramp up phase 416 is also maintained during the pierce phase 418 (e.g., to establish a sufficiently high pressure of the plasma fluid) to provide/maintain an arc that is sufficient for piercing through the workpiece to form a starting point for a cut.

A cut phase 420 initiates after the pierce phase 418 is completed. During the cut phase 420, the position of the valves 110, 111, 126 are maintained from that during the pierce phase 418 to direct shield fluid through the first line 106 and plasma fluid through the second line 108 while fluidly isolating the shield fluid and the plasma fluid from one another within the fluid control system 100. However, PID control of the proportional flow valve 134 is adjusted to provide plasma fluid flow more suitable for cutting the workpiece via the arc. By way of example, the proportional flow valve 134 may reduce the pressure of the plasma fluid from a sufficiently high pressure during the pierce phase 418 to maintain an arc that provides a better cut quality of the workpiece (e.g., as opposed to an arc more suitable for initiating a cut of the workpiece).

After the cut phase 420 has been completed (e.g., after the workpiece has been desirably cut), a ramp down phase 422 initiates. During the ramp down phase 422, the supply valve 111 closes, thereby blocking plasma fluid to the fluid control system 100. However, the supply valve 110 remains open to provide shield fluid to the fluid control system 100, such as to provide cooling to the torch 104. Moreover, the vent valve 140 opens during the ramp down phase 422 to discharge plasma fluid from the fluid control system 100. In some embodiments, the proportional flow valve 134 is operated at 0% duty cycle PWM to block plasma fluid flow to the second outlet 130, and the PID control of the proportional flow valve 132 is adjusted to direct shield fluid through the torch 104 in a manner that provides desirable cooling of the torch 104.

The ramp down phase 422 may be completed after another threshold duration of time has elapsed to indicate that the plasma fluid has been sufficiently discharged from the fluid control system 100. In response, a post flow phase 424 initiates by closing the vent valve 140 and opening the share valve 126. The supply valve 110 is also held open to direct shield fluid to the fluid control system 100. Consequently, shield fluid flows from the first line 106 to the second line 108 via the share valve 126, such as to remove any remaining plasma fluid from the second line 108. In some embodiments, the PID control of the proportional flow valve 132 is adjusted to direct shield fluid through the torch 104 to remove unwanted fluid (e.g., plasma fluid) and/or debris from the first line 106. Similarly, the proportional flow valve 134 is operated via PID control to direct shield fluid to remove unwanted fluid and/or debris from the second line 108. As an example, the configuration of the fluid control system 100 (e.g., control of the proportional flow valves 132, 134, positioning of the valves 110, 111, 126, 140) in the post flow phase 424 may be substantially similar as the configuration of the fluid control system 100 in the preflow phase 412.

In certain embodiments, the post flow phase 424 continues until the torch 104 has been sufficiently cooled (e.g., via shield fluid flow therethrough) to place the torch 104 in condition to initiate another cutting operation. After the post flow phase 424 has been completed, operation of the fluid control system 100 and of the torch system 98 may be suspended. Upon a subsequent initiation of a cutting operation of the torch system 98, the torch system 98 may initiate with the purge phase 408 and restart progression through the phases 408, 410, 412, 414, 416, 418, 420, 422, 424.

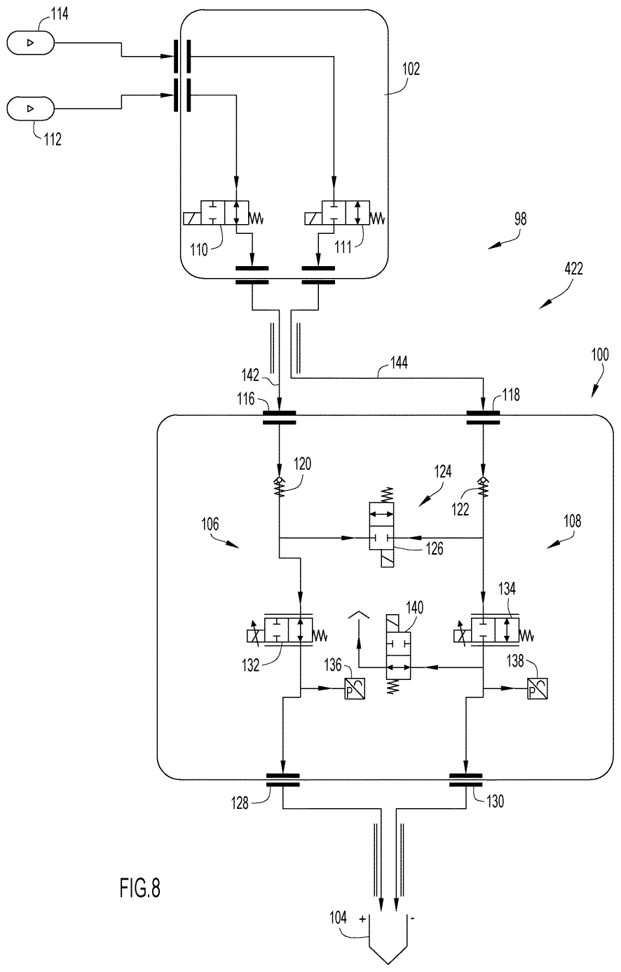

Each of FIGS. 5-8 illustrates the torch system 98 in a respective one of the phases discussed with respect to FIGS. 4A and 4B. In particular, FIG. 5 illustrates the torch system 98 in the transfer precharge phase 414, FIG. 6 illustrates the torch system 98 in the ramp up phase 416, FIG. 7 illustrates the torch system 98 in the cut phase 420, and FIG. 8 illustrates the torch system 98 in the ramp down phase 422.

In FIG. 5, the supply valve 110 is open to direct fluid (e.g., shield fluid) into the fluid control system 100 via the first inlet 116 and to the first one-way valve 120. The fluid directed by the supply valve 110 provides a pressure that opens the first one-way valve 120, thereby enabling fluid flow through the first line 106 via the first one-way valve 120. Meanwhile, the supply valve 111 is closed to block fluid flow (e.g., plasma fluid flow) to the second inlet 118 or is open to provide a pressure at one-way valve 122 that is insufficient to open one-way valve 122. Additionally, the share valve 126 opens to enable fluid flow from the first line 106 to the second line 108.

Fluid directed via the supply valve 110 substantially fills the fluid control system 100 and exerts an internal pressure against the second one-way valve 122 to urge the second one-way valve 122 to close. By way of example, the internal pressure exerted by the fluid against the second one-way valve 122 may be approximately equal to the supply pressure of the fluid at the supply line 142. This may avoid latency caused by a lead length/distance charge time to ramp the internal pressure against the second one-way valve 122 (e.g., to establish the target cracking pressure). Additionally or alternatively, the internal pressure against the second one-way valve 122 may be ramped in a manner that is not otherwise achievable as a result of a long lead length/distance. That is, the share valve 126 enables the cracking pressure of the second one-way valve 122 to be more readily achieved via fluid flow directed by the supply valve 110.

In FIG. 6, during the ramp up phase 416, the supply valve 111 remains open to direct fluid to the second one-way valve 122 via the second inlet 118. However, the share valve 126 is closed to block fluid flow from the first inlet 116 to the first line 106 and to the second line 108, thereby preventing or at least discouraging increase of the internal pressure against the second one-way valve 122. Initially, the fluid directed to the second one-way valve 122 via the second inlet 118 is not sufficient to overcome the internal pressure exerted against the second one-way valve 122 via the fluid directed to the second one-way valve 122 via the first inlet 116. Instead, fluid entering the fluid control system 100 near the second inlet 118 pressurizes at the second one-way valve 122, thereby precharging the supply line 144. Eventually, the pressure of the fluid is sufficient to overcome the internal pressure exerted against the second one-way valve 122, thereby opening the second one-way valve 122, as is depicted. In other words, by enabling flow between the lines 106, 108, the share valve 126 acts as a precharge mechanism to hold fluid at the supply line 144 until the fluid is sufficiently pressurized. Consequently, fluid flows from the second inlet 118 and through the second one-way valve 122 to mix with fluid directed from the first line 106 to the second line 108. The dashed arrows shown in FIG. 6 is indicative of flow of mixed fluids.

As a specific example, the fluid directed from the first inlet 116 to the second one-way valve 122 via the share line 124 establishes a cracking pressure of 200,000 Pa, or about 30 psi, of the second one-way valve 122. The supply valve 111 directs fluid to the second one-way valve 122, and the second one-way valve 122 will remain closed to block fluid flow from the second inlet 118 through the second one-way valve 122, until the fluid at the second inlet 118 has been pressurized to exceed the cracking pressure of 200,000 Pa. Upon being pressurized above the cracking pressure, the fluid at the second inlet 118 forces the second one-way valve 122 to open, thereby enabling fluid flow from the second inlet 118 through the second one-way valve 122.

Additionally or alternatively, to enable the second one-way valve 122 to open, the internal pressure exerted by fluid flow from the first line 106 to the second line 108 is reduced. To this end, the share line 124 may be closed to block fluid flow from the first line 106 to the second line 108, thereby causing the amount of fluid exerting the internal pressure against the second one-way valve 122 to passively decrease (e.g., through natural fluid flow out of the second line 108) and correspondingly causing natural decay of the internal pressure of the second one-way valve 122 and therefore natural decay of the cracking pressure of the second one-way valve 122. Eventually, the cracking pressure of the second one-way valve 122 decreases below the pressure of the fluid at the second inlet 118, thereby causing the second one-way valve 122 to open.

Accordingly, the share line 124 can be used to control opening of the second one-way valve 122, such as by harnessing cracking pressure decay to direct fluid from the supply line 144 through the second one-way valve 122 in proportion to the cracking pressure decay. In any case, the second one-way valve 122 may open to seamlessly introduce precharged fluid from the supply line 144 through the second one-way valve 122 to avoid pressure impulse as a result of natural changes in fluid pressure across the second one-way valve 122. Additionally, upon opening of the second one-way valve 122, precharged fluid is readily directed through the second one-way valve 122 at a sufficient pressure and/or flow rate to avoid latency issues related to ramping fluid pressure within the fluid control system 100 itself. In other words, instead of ramping pressure of fluid within the fluid control system 100 while the fluid is being directed from the second inlet 118 to the second outlet 130, the pressure of the fluid is immediately desirable when permitted to flow from the second inlet 118 to the second outlet 130. Thus, there is no need to rely on a natural ramping rate of pressure to charge the supply line 144. For instance, fluid directed from the second inlet 118 to the second outlet 130 may readily transfer a generated arc and avoid a latency that otherwise is present when ramping fluid pressure within the fluid control system 100.

Furthermore, in embodiments in which the share valve 126 is closed in order to use cracking pressure decay to open the second one-way valve 122, the pressure of fluid directed by the supply valve 110 may continue to ramp up (e.g., to provide desirable fluid pressure and/or flow rate to the torch 104 via the first line 106) without negatively inhibiting flow of fluid through the second one-way valve 122. For example, fluid pressure through the first line 106 may increase, and to avoid the fluid pressure increase at the first line 106 from undesirably raising the cracking pressure of the second one-way valve 122, the share valve 126 may be closed to block flow of the pressurized fluid from the first line 106 to the second line 108. Consequently, the fluid is contained within the first line 106 such that an increase in fluid pressure at the first line 106 will not further increase the cracking pressure of the second one-way valve 122. Instead, the cracking pressure of the second one-way valve 122 may decay upon closure of the share line 124.

Further still, throughout the ramp up phase 416, the proportional flow valves 132, 134 inside the fluid control system 100 can be carefully controlled, e.g., in the manner described above in connection with FIGS. 4A and 4B, to ensure that changes to the proportional flow valves 132, 134 do not adversely affect the characteristics of the fluid flowing towards the outlets 128, 130. Although embodiments of the present disclosure primarily discuss using fluid from the first line 106 to urge closure of the second one-way valve 122 (e.g., and thereby promote precharging fluid at the supply line 144), it should be noted that similar techniques may be utilized to use the fluid from the second line 108 to urge closure of the first one-way valve (e.g., and thereby promote precharging fluid at the supply line 142), such as by opening the share valve 126 to direct fluid from the second line 108 to the first line 106.

In FIG. 7, during the cut phase 420, the share valve 126 is closed such that each outlet 128, 130 receives an independent flow of gas. That is, the first line 106 directs fluid from the first inlet 116 to the first outlet 128 and not toward the second outlet 130, and the second line 108 directs fluid from the second inlet 118 to the second outlet 130 and not toward the first outlet 128. The respective fluid flows through the lines 106, 108 may maintain an arc to provide desirable cut quality via the torch system 98.

In FIG. 8, during the ramp down phase 422, the supply valve 111 is closed to block fluid flow to the second inlet 118, whereas the supply valve 110 remains open to direct fluid to first inlet 116. For example, the fluid control system 100 may continue to direct fluid through the first line 106 and into the torch 104 to cool the torch 104. Meanwhile, the share valve 126 remains closed to block fluid flow between the lines 106, 108. Moreover, the vent valve 140 opens to discharge fluid from the second line 108. For example, closing the supply valve 111 (e.g., in response to an absence of a signal provided to the supply valve 111) may trigger opening of the vent valve 140. Consequently, the vent valve 140 releases pressure built up adjacent to the second outlet 130, as well as in the torch 104. In some embodiments, the vent valve 140 allows the pressure in the torch 104 to decay at a rate similar to that of ramp down of current provided to the torch 104. To this end, the vent valve 140 utilizes a variable flow control (e.g., a needle valve, a proportional flow valve, a precalculated orifice equal to that of a needle valve) to tune the decay rate of pressure in the torch 104.

In some embodiments, the vent valve 140 also discharges fluid from the first line 106 (e.g., fluid remaining within the first line 106 after the torch 104 has been sufficiently cooled). To accomplish this, the share valve 126 opens to enable fluid flow from the first line 106 to the second line 108 and then to the vent valve 140. That is, the share valve 126 may enable fluid from both lines 106, 108 to discharge via the vent valve 140. In either case, the vent valve 140 can further facilitate removal of fluid from the torch system 98. For instance, the second outlet 130 or any other discharge orifice (e.g., of the torch 104) may not sufficiently discharge fluid from the second line 108 at a desirable flow rate. The vent valve 140 may be operated to increase discharge of fluid from the second line 108, such as without having to rely on natural decay occurring absent the vent valve 140. By removing fluid from the second line 108, the fluid control system 100 may help place the torch system 98 in condition for initiating a subsequent operation. As an example, after the arc is terminated, the vent valve 140 may be closed to provide a desirable amount of fluid within the fluid control system 100 (e.g., in the second line 108) to impart a pressure against the second one-way valve 122 and establish an increased cracking pressure of the second one-way valve 122, thereby enabling operation of the torch system 98 to initiate without having to direct shield fluid through the fluid control system 100 and establish the increased cracking pressure of the second one-way valve 122.

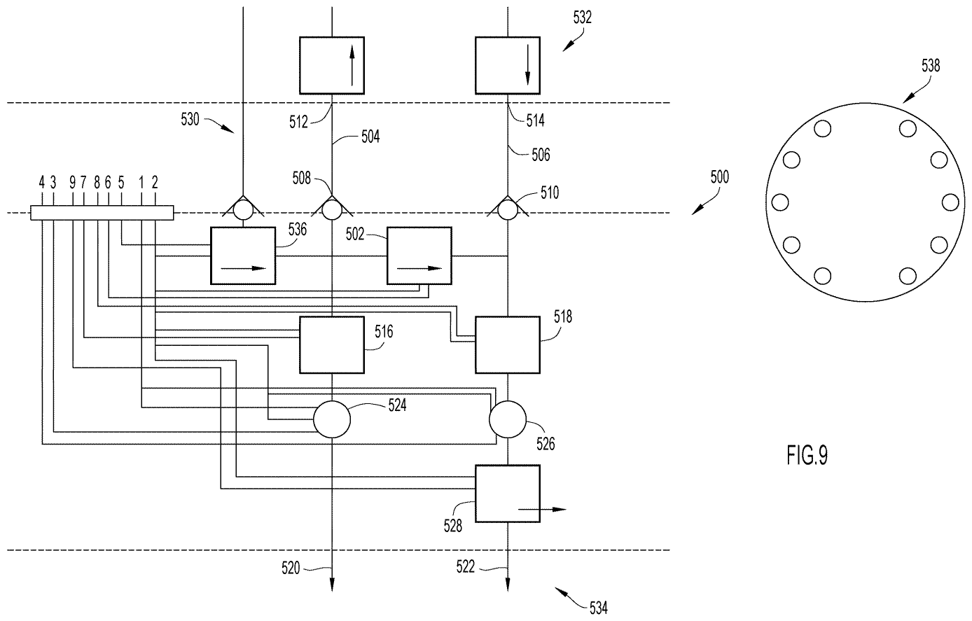

Now turning to FIG. 9, this Figure illustrates another embodiment of a fluid control system 500 formed in accordance with the techniques presented herein. At a high-level, the fluid control system 500 is largely similar to the fluid control system 100 because it includes a share valve 502 connecting two lines 504, 506 that have respective one-way valves 508, 510 controlling fluid from the inlets 512, 514, respectively. The fluid control system 500 also includes proportional flow valves 516, 518 to control fluid flow to outlets 520, 522, respectively, pressure sensors 524, 526 configured to detect pressure within the lines 504, 506, respectively, and a single vent valve 528 configured to discharge fluid from the line 506. However, now, the fluid control system 500 also includes a water mist system 530 configured to introduce water to the line 504 (e.g., a shield line). The fluid control system 500 is configured to operate the water mist system 530 to deliver water to line 504 (e.g., a shield line) and potentially to the line 506 (e.g., a plasma line).

More specifically, in FIG. 9, the fluid control system 500 is configured to receive fluid (e.g., plasma fluid) from a power supply 532 and direct the fluid to a torch 534 (e.g., a plasma chamber of the torch 534) via the line 506. The fluid control system 500 is also configured to receive fluid (e.g., shield fluid) from the power supply 532 and direct the fluid to the torch 534 via the line 504. The share valve 502 fluidly couples to the lines 504, 506 to one another. Similar to the fluid control system 100, the fluid control system 500 provides an arc process fluid control arrangement that can quickly change the pressure and composition of fluid supplied to the torch 534, such as to correspond to different phases of a cutting operation, with an arrangement and operation of valves 502, 508, 510, 516, 518, 528, such as by controlling precharge of a fluid within one of the lines 504, 506 using fluid exerting pressure on the one-way valve 508, 510 of the other line 504, 506. In at least some embodiments, all of these valves of the fluid control system 500 and/or of the fluid control system 100 may be cleaned of hydrocarbon residue and endowed with fluoropolymer seals to handle oxygen degradation which may otherwise affect seals made of nitrile rubber.

To be clear, just because FIG. 9 shows a water mist system 530 does not mean that other embodiments cannot utilize water in one or more the lines. Instead, with the fluid control system 500—or with the fluid control system 100—the specific fluid introduced into each line should depend upon the material being processed. For example, when cutting mild steel, oxygen is likely to be connected to the line 506 and compressed air to the line 504. By comparison, when cutting stainless steel or aluminum, H35 would be connected to the line 506 and nitrogen would be connected to the line 504. Water mist may be introduced in both implementations.

Similar to operation of the fluid control system 100 during a cutting operation, for the fluid control system 500, fluid is initially directed to the fluid control system 500 via the inlet 512, whereas fluid flow to the fluid control system 500 via the inlet 514 is initially blocked. Further, the share valve 502 is opened to enable fluid flow from the line 504 to the line 506. Consequently, fluid flows from the inlet 512 to both outlets 520, 522, as well as against the one-way valve 510 to urge the one-way valve 510 to close and establish a target cracking pressure of the one-way valve 510. Once a target cracking pressure of the one-way valve 510 is established or the cracking pressure of the one-way valve 510 is being ramped toward the target cracking pressure, fluid is directed to the one-way valve 510 via the inlet 514. However, because of the established target cracking pressure of the one-way valve 510, such fluid does not immediately open the one-way valve 510. Instead, the fluid precharges. An arc is then generated and transferred to a workpiece.

Just prior to arc transfer, fluid flow to the inlet 514 is ceased but recommences a preset period of time after arc transfer. In some instances, fluid flow to the inlet 512 is also momentarily blocked. In either case, fluid at the inlet 514 is sufficiently pressurized to open the one-way valve 510, thereby mixing with fluid directed from the inlet 512 to the line 506. Consequently, the outlet 522 receives a mixture of fluid from both lines 504, 506, whereas the outlet 520 receives fluid from the line 504 and not from the line 506. After the arc is at a desirable cut current, the share valve 502 is closed to isolate the fluids from one another to maintain the arc for cutting the workpiece. After cutting of the workpiece has been completed, the single vent valve 528 is opened and the fluid flow to the inlet 514 is blocked. Thus, fluid from the line 506 is discharged, such as to provide a decay rate that matches a current ramp down. After the fluid is sufficiently discharged from the line 506, the vent valve 528 is closed.

Additionally, the water mist system 530 may be operated to provide water mist during any suitable phase of the cutting operation. By way of example, a water mist valve 536 of the water mist system 530 is initially closed prior to arc generation and transfer. However, after the arc has been transferred to the workpiece and after the share valve 502 closes to maintain the arc by isolating fluid flows through the lines 504, 506, the water mist valve 536 opens to provide water mist to the line 504. Therefore, a mixture of water mist and fluid is directed through the line 504, such as to enhance cooling of the torch 534 by directing water mist therethrough while maintaining the arc (e.g., by shielding the arc via shield fluid). In some embodiments, fluid flow to the inlet 512 is blocked upon opening the water mist valve 536, thereby directing water mist through the line 504 without directing fluid from the inlet 512 through the line 504.

In additional or alternative embodiments, the water mist system 530 is operated to remove fluid from the lines 504, 506. By way of example, during or after fluid discharge from the line 506 (e.g., while the vent valve 528 is open), the water mist valve 536 opens to direct water mist to the line 504, and the share valve 502 opens to direct water mist from the line 504 to the line 506. Therefore, water mist flows through both lines 504, 506 and may further facilitate removal of fluid from the fluid control system 500.

FIG. 9 also illustrates a control arrangement 538 for the fluid control system 500. Notably, the entire fluid control system 500 may utilize 10 pins or fewer, such as seven pins (e.g., using electrical CANBUS protocol), for controlling the various valves 502, 516, 518, 528, 536. Limiting the pin quantity, as well as the complexity of component arrangements, provides costs savings during manufacturing and eases the maintenance and upkeep required for an end user. By comparison, gas control for a plasma cutting torch that otherwise offers precise control of flow/pressure in two different lines, and very precise control of the transfer and selection of these gases at the plasma cutting torch, often requires a relatively greater number of valves, discrete timing intervals for firing these valves, and expensive manifolding of the wetted path for gas control (in order to maintain oxygen safety, high cut quality, and acceptable consumable life performance). All of these items are expensive but can be largely avoided with the techniques presented herein. In fact, the present techniques avoid these expenses while still offering the dynamic control required for various stages of arc processing operations—such as the pilot and ramp up phase of establishing a thermal plasma arc, a cut phase where a specific pressure setpoint is held to maintain the thermal plasma arc, and a ramp down phase that reduces fluid flow (e.g., in accordance to an arc's current profile) while maintaining a useful lifespan of torch components.

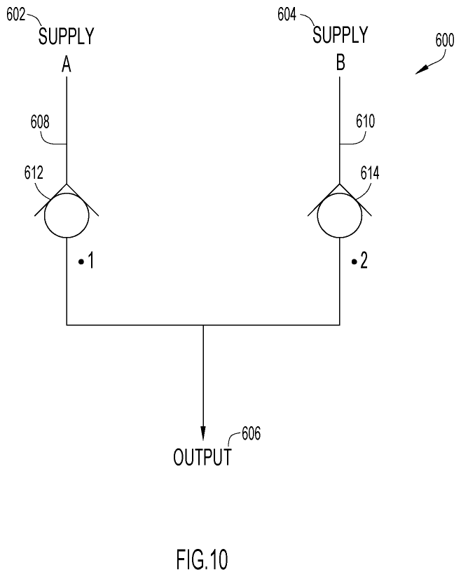

Now turning to FIG. 10, this Figure illustrates the advantages of check valves of a fluid control system 600 presented herein at a higher level of abstraction. As has been mentioned, generally, the composition and pressures of both a first fluid and a second fluid supplied to a plasma cutting torch are varied depending on a phase of a cutting operation to reduce the wear of the consumables. For example, during arc initiation, a plasma chamber and a shield path of the torch are often supplied with a first fluid (e.g., a shield fluid), and after arc initiation, the plasma chamber and the shield path may be supplied with a second fluid (e.g., a plasma fluid), or a mixture of the first fluid and the second fluid. The pressure, type, and/or composition of fluid(s) supplied to the torch must be carefully controlled to correspond to each phase of the cutting operation to prevent excess wear of the consumables, e.g., electrode, nozzle/tip, shield, etc.

In FIG. 10, a first fluid supply 602 (Supply A) and a second fluid supply 604 (Supply B) are fluidly coupled to a torch 606 (output) via supply lines 608, 610 (1, 2). The supply lines 608, 610 each include a respective one-way valve 612, 614 at or near the torch 606 to control the fluid pressure and fluid composition supplied to the torch 606. Each one-way valve 612, 614 allows flow in one direction—from the respective fluid supply 602, 604 towards the torch 606—and blocks flow in an opposite direction—from the torch 606 toward the respective fluid supply 602, 604. The supply lines 608, 610 are connected to one another upstream of the torch 606. Therefore, the respective fluids directed through the supply lines 608, 610 may mix with one another. A composition of fluid (e.g., a fluid mixture) directed to the torch 606 may be provided by controlling a cracking pressure for each one-way valve 612, 614.

In particular, the cracking pressure for each one-way valve 612, 614 can be set depending on the fluid pressure introduced to the opposing line. For example, the cracking pressure for the one-way valve 612 of the supply line 608 may be set based on the fluid pressure introduced from the supply line 610 to the one-way valve 612, whereas the cracking pressure for the one-way valve 614 of the supply line 610 may be set based on the fluid pressure introduced from the supply line 608 to the one-way valve 614. Additionally or alternatively, the pressures in the supply lines 608, 610 may be adjusted such that both one-way valves 612, 614 may be cracked open to provide a mixture of the first fluid and the second fluid to the torch 606 at a desired pressure and composition. In a specific implementation, fluid is directed through the supply line 610 to increase the fluid pressure to overcome the cracking pressure of the one-way valve 614 to either (i) create a back pressure to close the one-way valve 612 or (ii) cause the fluid directed through the supply line 608 and the fluid directed through the supply line 610 to mix and pressurize at a desired pressure and composition for flow to the torch 606. For instance, the difference in pressure of the respective fluid directed through the supply lines 608, 610 may control the volumetric mixing percentages in that the volumetric mixing percentages are proportional to the relative fluid pressures. In any case, the arrangement depicted in FIG. 10 allows the fluid control system 600 to precisely and almost instantaneously control the pressure and composition of a fluid and/or a mixture of fluids supplied to the torch 606 by merely controlling the pressures of the fluids at the respective fluid supply lines 608, 610. This fluid control system 600 is also passive (e.g., avoids actively regulating pressure of fluid directed through the supply lines 608, 610), which reduces the amount of control and expense required for implementation.

By using the one-way valves 612, 614 presented herein, the fluid control system 600 of the present application avoids, minimizes, or eliminates the need to send electrical control signals close to the torch 606. By comparison, if control signals are sent (e.g., from a power supply) to a valve in the torch 606, there will be a lag between receiving a control signal and increasing fluid pressure at the torch 606 until a desired fluid pressure has been reached. Additionally, when the control signals travel toward the torch 606, interference from a process current may negatively impact the control signal. The plasma arc generated at the torch 606 can also create interference. Moreover, placing the valves at a sufficient distance away from the torch 606 to mitigate the interference issues may increase the lag time between control signal transmission and increase of fluid pressure. With two one-way valves 612, 614 arranged on two supply lines 608, 610 (e.g., connected by a share line), the one-way valves 612, 614 allow for: (a) precharging of either supply line 608, 610, (b) quick switching between fluids directed through the supply lines 608, 610, and/or (c) providing a mixture of fluids from the supply lines 608, 610 during different stages of an arc processing operation. The one-way valves 612, 614 are controlled by adjusting the pressures of the fluid directed by the fluid supplies (e.g., at a power supply). That is, desirable operation of the fluid control system 600 to provide fluid to the torch 606 may be achieved without having to utilize other valves other than the one-way valves 612, 614 used along the supply lines 608, 610. The fluid control system 600 therefore operates to maintain a desired pressure and fluid type/composition for each phase of the cutting operation, while also reducing any lag between phases due to charging of supply lines 608, 610 and avoiding implementation of more complex fluid control arrangements.

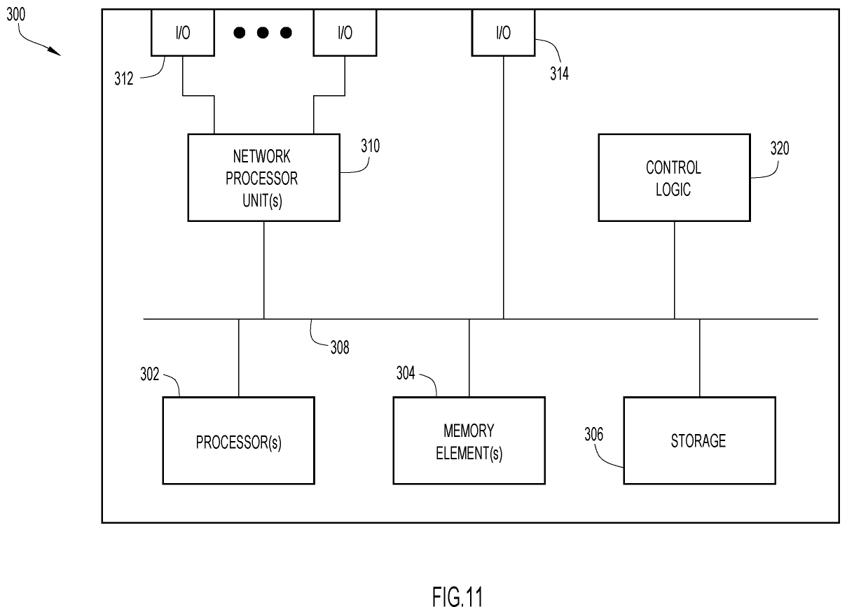

Referring to FIG. 11, a hardware block diagram of a computing device 300 is illustrated. The illustrated computing device 300 may be an example of a control system as described above. The computing device 300 may perform functions associated with the operations discussed herein in connection with the techniques described herein with reference to FIGS. 1A, 1i, and 2-10. The computing device 300 may be incorporated in any of the arc process system devices discussed herein and may be configured to perform the operations discussed herein for controlling one or more parameters of the arc process operation, including controlling one or more flows of fluids to the torch. Thus, any of the components, such as the controller 16, the automated plasma arc torch 18, the power supply 14, and/or the positioning system 12 of the automated cutting system 10, the fluid control system 100 of the torch system 98, the fluid control system 500, and/or the fluid control system 600, may execute the techniques presented herein, alone or in combination with one or more other systems/components.

In at least one embodiment, the computing device 300 may be any apparatus that may include one or more processor(s) 302, one or more memory element(s) 304, storage media 306, a bus 308, one or more network processor unit(s) 310 interconnected with one or more network input/output (I/O) interface(s) 312, one or more I/O interface(s) 314, and control logic 320. In various embodiments, instructions associated with logic for the computing device 300 can overlap in any manner and are not limited to the specific allocation of instructions and/or operations described herein.

In at least one embodiment, the processor(s) 302 is/are at least one hardware processor configured to execute various tasks, operations and/or functions for the computing device 300 as described herein according to software and/or instructions configured for the computing device 300. The processor(s) 302 can execute any type of instructions associated with data to achieve the operations detailed herein. In one example, the processor(s) 302 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term “processor.”

In at least one embodiment, the memory element(s) 304 and/or the storage media 306 is/are configured to store data, information, software, and/or instructions associated with the computing device 300, and/or logic configured for the memory element(s) 304 and/or the storage media 306. For example, any logic described herein (e.g., the control logic 320) can, in various embodiments, be stored for the computing device 300 using any combination of the memory element(s) 304 and/or the storage media 306. Note that in some embodiments, the storage media 306 can be consolidated with memory element(s) 304 (or vice versa) or can overlap/exist in any other suitable manner.

In various embodiments, any entity, apparatus, or device as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad terms “memory element” and “storage media.” Data/information being tracked and/or sent to one or more entities, apparatuses, or devices as discussed herein could be provided in any database, table, register, list, cache, storage, and/or storage structure: all of which can be referenced at any suitable timeframe. Any such storage options may also be included within the broad terms “memory element” and “storage media” as used herein.

Note that in certain example implementations, operations as set forth herein may be implemented by logic (as described herein; e.g., the control logic 320) encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software (potentially inclusive of object code and source code), etc.) for execution by the one or more processor(s) 302, and/or other similar machine(s), etc. Generally, this includes the memory element(s) 304 and/or the storage media 306 being able to store data, software, code, instructions (e.g., processor instructions), logic (e.g., the control logic 320), parameters, combinations thereof, or the like that are executed to carry out operations in accordance with teachings of the present disclosure.

To the extent that embodiments presented herein relate to the storage of data, the embodiments may employ any number of any conventional or other databases, data stores or storage structures (e.g., files, databases, data structures, data, or other repositories, etc.) to store information.

In at least one embodiment, the bus 308 can be configured as an interface that enables one or more elements of the computing device 300 to communicate in order to exchange information and/or data. The bus 308 can be implemented with any architecture designed for passing control, data and/or information between the processor(s) 302, the memory element(s) 304, the storage media 306, peripheral devices, and/or any other hardware and/or software components that may be configured for the computing device 300. In at least one embodiment, the bus 308 may be implemented as a fast kernel-hosted interconnect, potentially using shared memory between processes (e.g., logic), which can enable efficient communication paths between the processes.

In various embodiments, the network processor unit(s) 310 may enable communication between the computing device 300 and other systems, entities, devices, etc., via the network I/O interface(s) 312 (wired and/or wireless) to facilitate operations discussed for various embodiments described herein. In various embodiments, the network processor unit(s) 310 can be configured as a combination of hardware and/or software, such as one or more Ethernet driver(s) and/or controller(s) or interface cards, Fiber Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between the computing device 300 and other arc process system devices, arc process system auxiliary components, etc. to facilitate the operations described herein. In various embodiments, the network I/O interface(s) 312 can be configured as one or more Ethernet port(s), Fiber Channel ports, any other I/O port(s), and/or antenna(s)/antenna array(s) now known or hereafter developed. Thus, the network processor unit(s) 310 and/or the network I/O interface(s) 312 may include suitable interfaces for receiving, transmitting, and/or otherwise communicating data and/or information in a network environment.

The I/O interface(s) 314 allow for input and output of data and/or information with other entities that may be connected to the computing device 300. For example, the I/O interface(s) 314 may provide a connection to arc process system devices and/or components. In some implementations, the I/O interface(s) 314 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, the control logic 320 can include instructions that, when executed, cause the processor(s) 302 to perform operations, which can include, but are not limited to: controlling the pressure of one or more fluids supplied to the torch; changing various parameters of the arc process operation; providing overall control operations of the arc process system; interacting with other entities, devices, components, systems, etc. described herein; maintaining and/or interacting with stored data, information, parameters, etc. (e.g., the memory element(s) 304, the storage media 306, data structures, databases, tables, etc.); and/or combinations thereof to facilitate various operations for embodiments described herein.

The programs described herein (e.g., the control logic 320) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

References herein to various features (e.g., elements, structures, nodes, modules, components, engines, logic, steps, operations, functions, characteristics, etc.) included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that a module, engine, client, controller, function, logic or the like as used herein, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity and does not in itself dictate a relationship between the various embodiments and/or configurations discussed.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of,” “one or more of,” “and/or,” variations thereof, or the like are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first,” “second,” “third,” etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

1. A torch system, comprising:
a fluid control system, comprising:
a first fluid line configured to direct a first fluid within the fluid control system;
a second fluid line configured to direct a second fluid within the fluid control system, wherein the second fluid line comprises a one-way valve configured to enable fluid flow through the second fluid line in a first direction and block fluid flow through the second fluid line in a second direction; and
a share fluid line fluidly coupling the first fluid line and the second fluid line to one another downstream of the one-way valve, wherein the share fluid line comprises a share valve configured to control fluid flow through the share fluid line; and
a controller communicatively coupled to the share valve, wherein the controller is configured to:
open the share valve to direct the first fluid from the first fluid line to the second fluid line and against a downstream side of the one-way valve to establish a cracking pressure of the one-way valve; and
open a supply valve to direct the second fluid to the one-way valve to pressurize the second fluid toward the cracking pressure.

2. The torch system of claim 1, wherein the controller is configured to close the share valve upon establishing the cracking pressure of the one-way valve.

3. The torch system of claim 2, wherein the controller is configured to open the supply valve while the share valve is closed to direct the second fluid to open the one-way valve by overcoming the cracking pressure, thereby enabling the second fluid to flow and mix with remaining first fluid in the second fluid line.

4. The torch system of claim 3, wherein the controller is configured to maintain the supply valve opened and the share valve closed after the second fluid overcomes the cracking pressure to direct the first fluid and the second fluid through the first fluid line and the second fluid line, respectively.

5. The torch system of claim 3, wherein the controller is configured to close the supply valve while the share valve is closed to block flow of the second fluid through the fluid control system.

6. The torch system of claim 5, wherein the controller is configured to maintain an additional supply valve opened after the supply valve is closed to direct the first fluid through the first fluid line to cool the torch system.

7. The torch system of claim 5, comprising a vent valve configured to open while the supply valve is closed to discharge the second fluid from the second fluid line.

8. The torch system of claim 7, wherein the controller is configured to open the share valve while the vent valve is open to direct the first fluid from the first fluid line to the second fluid line toward the vent valve to discharge the first fluid from the fluid control system.

9. The torch system of claim 1, wherein the second fluid line comprises a proportional flow valve configured to control fluid flow through the second fluid line, and the controller is configured to adjust the proportional flow valve to control flow of the first fluid through the second fluid line and against the one-way valve to establish the cracking pressure of the one-way valve.

10. A method, comprising:
opening a first supply valve to direct a first fluid through a first fluid line of a plasma torch system;
opening a share valve fluidly coupling the first fluid line and a second fluid line of the plasma torch system to direct the first fluid to the second fluid line and against a downstream side of a one-way valve, wherein the one-way valve is configured to enable fluid flow through the second fluid line in a first direction and block fluid flow through the second fluid line in a second direction such that directing the first fluid against the one-way valve establishes a cracking pressure to block fluid flow through the second fluid line; and
opening a second supply valve to direct a second fluid to the one-way valve to pressurize the second fluid toward the cracking pressure.

11. The method of claim 10, comprising opening the second supply valve to pressurize the second fluid above the cracking pressure to open the one-way valve and enable flow of the second fluid in the second direction through the second fluid line.

12. The method of claim 11, comprising closing the share valve to block fluid flow between the first fluid line and the second fluid line while the first fluid is directed through the first fluid line and the second fluid is directed through the second fluid line.

13. The method of claim 11, comprising:
closing the second supply valve to block the second fluid from flowing through the second fluid line; and
maintaining the first supply valve opened after closing the second supply valve to direct the first fluid through the first fluid line to cool the plasma torch system.

14. The method of claim 10, comprising adjusting a proportional flow valve configured to control fluid flow out of the second fluid line to control flow of the first fluid through the second fluid line and against the one-way valve to establish the cracking pressure.

15. A fluid control system for an arc processing system, the fluid control system comprising:
a first fluid line configured to direct a first fluid toward a torch of the arc processing system;
a second fluid line configured to direct a second fluid toward the torch, wherein the second fluid line comprises a one-way valve configured to enable fluid flow through the second fluid line toward the torch and block fluid flow through the second fluid line away from the torch; and
a share fluid line fluidly coupled to the first fluid line and the second fluid line downstream of the one-way valve, wherein the share fluid line is configured to direct the first fluid from the first fluid line to the second fluid line and against a downstream side of the one-way valve to establish a cracking pressure of the one-way valve to enable the second fluid to pressurize in the second fluid line toward the cracking pressure.

16. The fluid control system of claim 15, wherein the share fluid line comprises a share valve configured to open to direct the first fluid from the first fluid line to the second fluid line and configured to close to block flow of the first fluid from the first fluid line to the second fluid line.

17. The fluid control system of claim 15, wherein the second fluid comprises plasma fluid for generating an arc for the torch of the arc processing system, and the first fluid directed by the first fluid line comprises shield fluid for maintaining the arc.

18. The fluid control system of claim 15, wherein the second fluid line comprises a proportional flow valve configured to control fluid flow from the second fluid line toward the torch to control flow of the first fluid against the one-way valve to establish the cracking pressure.

19. The fluid control system of claim 15, wherein the share fluid line is configured to direct the second fluid from the second fluid line to the first fluid line.

20. The fluid control system of claim 15, wherein the one-way valve is configured to open in response to the second fluid pressurizing in the second fluid line above the cracking pressure established by the first fluid directed against the one-way valve.
